(19) United States
(12) Patent Application Publication
(10) Pub. No.: US 2009/0013239 A1
(43) Pub. Date: Jan. 8, 2009

(54) LDPC (Low Density Parity Check) decoder employing distributed check and/or variable node architecture

(75) Inventor: Andrew J. Blanksby, Orange, CA (US)

Correspondence Address: GARLICK HARRISON & MARKISON, P.O. BOX 160727, AUSTIN, TX, 78716-0727, US

(73) Assignee: BROADCOM CORPORATION, Irvine, CA (US)

(21) Appl. No.: 11/830,639

(22) Filed: Jul. 30, 2007

Related U.S. Application Data
(60) Provisional application No. 60/958,087, filed on Jul. 2, 2007.

(51) Int. Cl. G06F 11/00

(52) U.S. Cl. 714/801; 714/E11.001

(57) ABSTRACT

LDPC (Low Density Parity Check) decoder employing distributed check into variable node architecture. A means of decoding processing is presented in which at least one portion of the check node processing functionality is actually integrated into the variable/bit node processing functionality (e.g., distributed check node embodiment). In alternative embodiments, at least one portion of the variable/bit node processing functionality is actually integrated into the check node processing functionality (e.g., distributed variable/bit node embodiment). In even other embodiments, some check node processing functionality is moved and integrated into the variable/bit node processing functionality, and some variable/bit node processing functionality is also moved and integrated into the check node processing functionality (e.g., combined distributed embodiment). It is also noted that, when appropriately selected, the modification of the check engine and bit engine can also allow for reduction in routing layout between such a check engine and bit engine within a communication device.

### CROSS REFERENCE TO RELATED PATENTS/PATENT APPLICATIONS

### Provisional Priority Claims

The present U.S. Utility patent application claims priority pursuant to 35 U.S.C. § 119(e) to the following U.S. Provisional Patent Application which is hereby incorporated herein by reference in its entirety and made part of the present U.S. Utility patent application for all purposes:

1. U.S. Provisional Application Ser. No. 60/958,087, entitled “LDPC (Low Density Parity Check) decoder employing distributed check into variable node architecture,” (Attorney Docket No. BP6092), filed Jul. 2, 2007, pending.

### BACKGROUND OF THE INVENTION

1. Technical Field of the Invention

The invention relates generally to communication systems; and, more particularly, it relates to decoding of LDPC (Low Density Parity Check) coded signals within such communication systems.

2. Description of Related Art

Data communication systems have been under continual development for many years. One such type of communication system that has been of significant interest lately is a communication system that employs iterative error correction codes. Of particular interest is a communication system that employs LDPC (Low Density Parity Check) code. Communications systems with iterative codes are often able to achieve lower bit error rates (BER) than alternative codes for a given signal to noise ratio (SNR).

A continual and primary directive in this area of development has been to try continually to lower the SNR required to achieve a given BER within a communication system. The ideal goal has been to try to reach Shannon's limit in a communication channel. Shannon's limit may be viewed as being the data rate to be used in a communication channel, having a particular SNR, that achieves error free transmission through the communication channel. In other words, the Shannon limit is the theoretical bound for channel capacity for a given modulation and code rate.

LDPC code has been shown to provide for excellent decoding performance that can approach the Shannon limit in some cases. For example, some LDPC decoders have been shown to come within 0.3 dB (decibels) from the theoretical Shannon limit. While this example was achieved using an irregular LDPC code with a length of one million, it nevertheless demonstrates the very promising application of LDPC codes within communication systems.

The use of LDPC coded signals continues to be explored within many newer application areas. Some examples of possible communication systems that may employ LDPC coded signals include communication systems employing 4 wire twisted pair cables for high speed Ethernet applications (e.g., 10 Gbps (Giga-bits per second) Ethernet operation according to the IEEE 802.3an (10GBASE-T) emerging standard) as well as communication systems operating within a wireless context (e.g., in the IEEE 802.11 context space including the IEEE 802.11n emerging standard).

For any of these particular communication system application areas, near-capacity achieving error correction codes are very desirable. The latency constraints, which would be involved by using traditional concatenated codes, simply preclude their use in such applications in very high data rate communication system application areas.

Generally speaking, within the context of communication systems that employ LDPC codes, there is a first communication device at one end of a communication channel with encoder capability and second communication device at the other end of the communication channel with decoder capability. In many instances, one or both of these two communication devices includes encoder and decoder capability (e.g., within a bi-directional communication system). LDPC codes can be applied in a variety of additional applications as well, including those that employ some form of data storage (e.g., hard disk drive (HDD) applications and other memory storage devices) in which data is encoded before writing to the storage media, and then the data is decoded after being read/retrieved from the storage media.

In many such prior art communication devices, one of the greatest hurdles and impediments in designing effective devices and/or communication devices that can decode LDPC coded signals is the typically large area and memory required to store and manage all of the updated bit edge messages and check edge messages that are updated and employed during iterative decoding processing (e.g., when storing and passing the check edges messages and the bit edges messages back and forth between a check engine and a bit engine, respectively). When dealing with relatively large block sizes in the context of LDPC codes, the memory requirements and memory management need to deal with these check edges messages and bit edges messages can be very difficult to handle. There has been and continues to be a need in the art for better means by which LDPC coded signal can be decoded to extract the information encoded therein.

Moreover, when the size of a low density parity check matrix, H, employed to decode an LDPC coded signal reaches a certain size, the interconnectivity between a first processing module and a second processing module (e.g., a check engine and a bit engine) can significantly increase.

### BRIEF SUMMARY OF THE INVENTION

The present invention is directed to apparatus and methods of operation that are further described in the following Brief Description of the Several Views of the Drawings, the Detailed Description of the Invention, and the claims. Other features and advantages of the present invention will become apparent from the following detailed description of the invention made with reference to the accompanying drawings.

### BRIEF DESCRIPTION OF THE SEVERAL VIEWS OF THE DRAWINGS

FIG. 1 and FIG. 2 illustrate various embodiments of communication systems.

FIG. 3 illustrates an embodiment of an apparatus that is operable to perform LDPC decoding processing.

FIG. 4 illustrates an alternative embodiment of an apparatus that is operable to perform LDPC decoding processing.

FIG. 5 illustrates an embodiment of an LDPC (Low Density Parity Check) code bipartite graph.

FIG. 6 illustrates an embodiment of LDPC decoding functionality.

FIG. 7 illustrates an alternative embodiment of LDPC decoding functionality.

FIG. 8 illustrates relationships between the bit engines and check engines of the FIG. 6 and FIG. 7.

FIG. 9, FIG. 10, and FIG. 11 operate in conjunction with one another in embodiment [I].

FIG. 9 illustrates an embodiment of variable/bit node processing in accordance with LDPC decoding functionality.

FIG. 10 illustrates an embodiment of check node processing (sign) in accordance with LDPC decoding functionality.

FIG. 11 illustrates an embodiment of check node processing (magnitude) in accordance with LDPC decoding functionality.

FIG. 12, FIG. 13, and FIG. 14 operate in conjunction with one another in embodiment [II] which employs a distributed variable/bit node architecture.

FIG. 12 illustrates an embodiment of variable/bit node processing in accordance with LDPC decoding functionality of embodiment [II].

FIG. 13 illustrates an embodiment of check node processing (sign) in accordance with LDPC decoding functionality of embodiment [II].

FIG. 14 illustrates an embodiment of check node processing (magnitude) in accordance with LDPC decoding functionality of embodiment [II].

FIG. 15, FIG. 16, and FIG. 17 operate in conjunction with one another in embodiment [III] which employs a distributed check node architecture.

FIG. 15 illustrates an embodiment of variable/bit node processing in accordance with LDPC decoding functionality of embodiment [III].

FIG. 16 illustrates an embodiment of check node processing (sign) in accordance with LDPC decoding functionality of embodiment [III].

FIG. 17 illustrates an embodiment of check node processing (magnitude) in accordance with LDPC decoding functionality of embodiment [III].

FIG. 18, FIG. 19, and FIG. 20 operate in conjunction with one another in embodiment [IV] which employs a combined distributed variable/bit node and check node architecture.

FIG. 18 illustrates an embodiment of variable/bit node processing in accordance with LDPC decoding functionality of embodiment [IV].

FIG. 19 illustrates an embodiment of check node processing (sign) in accordance with LDPC decoding functionality of embodiment [IV].

FIG. 20 illustrates an embodiment of check node processing (magnitude) in accordance with LDPC decoding functionality of embodiment [IV].

FIG. 21, FIG. 22, and FIG. 23 operate in conjunction with one another in embodiment [IV] which employs a min-sum combined distributed variable/bit node and check node architecture.

FIG. 21 illustrates an embodiment of variable/bit node processing in accordance with LDPC decoding functionality of embodiment [V].

FIG. 22 illustrates an embodiment of check node processing (sign) in accordance with LDPC decoding functionality of embodiment [V].

FIG. 23 illustrates an embodiment of check node processing (magnitude) in accordance with LDPC decoding functionality of embodiment [V].

FIG. 24, FIG. 25, FIG. 26, and FIG. 27 illustrate alternative embodiments of a method for processing an LDPC coded signal.

### DETAILED DESCRIPTION OF THE INVENTION

LDPC (Low Density Parity Check) codes are capacity approaching forward error correcting codes (ECCs) that are being adopted in an increasing number of communication standards (e.g., IEEE 802.3an, IEEE 802.11n, 802.20, DVB-S2). Relevant application domains include magnetic recording, wireless, and high speed data transmission over copper and optical fiber.

In one embodiment, LDPC decoding processing is performed using an iterative decoding approach in which messages (e.g., check edge messages and bit edge messages [or alternatively referred to as “variable edge messages”]) are passed back and forth when performing check node processing (sometimes alternatively referred to as check engine processing) and bit node processing (sometimes alternatively referred to as bit engine processing). This is sometimes refereed to as message passing decoding processing that operates on a graph representation of the code (e.g., a LDPC bipartite graph (also sometimes referred to as a “Tanner” graph in the art)).

A novel means is presented herein in which a portion of the functionality is moved from a check engine to a variable/bit engine. The portion of functionality from the check engine is actually integrated into the variable/bit engine such that the updating of a bit edge message within a variable/bit engine (e.g., using a most recently, partially updated check edge message) performs the completion of the updating of the recently, partially updated check edge message during the bit node processing.

This novel architecture can also be implemented to provide for a reduction in top level routing complexity. In other words, the complexity of the connectivity between a check engine and bit engine can be reduced by provisioning at least one portion of the functionality of the check engine actually into the bit engine. From some perspectives, the check engine (after having a portion of its functionality removed there from) is a modified check engine, and the bit engine (after having a portion of the check engine functionality added thereto) is a modified bit engine.

The check update computation (e.g., the check engine functionality) is split so that after the check sum is formed (e.g., thereby producing only a partially updated check edge message), the check sum (i.e., not a fully updated check edge message) is re-distributed to participating variable/bit nodes which must now contain the additional hardware to implement the individual message check output calculation.

If the floor plan of the decoder allows the check sum to be distributed as a bus or tree, this will result in lower routing complexity than distributing individual check edge messages to the variable/bit nodes (i.e., the bit engines). In addition, the reduction in routing complexity also depends on the number of bits used to represent the check sum (e.g., wₛᵤₘ), the number of bits used to represent the check output messages (e.g., the check edge messages, having w_{cv} bits each), and the added complexity of the additional set of check output functions required at the modified variable/bit node update (e.g., the additional module, processor, and/or functional block within bit engine).

It is noted that any of the following embodiments and approaches described herein are applicable regardless of the overall LDPC decoder architecture, e.g., whether fully parallel, partially parallel, or serial in architecture/hardware implementation.

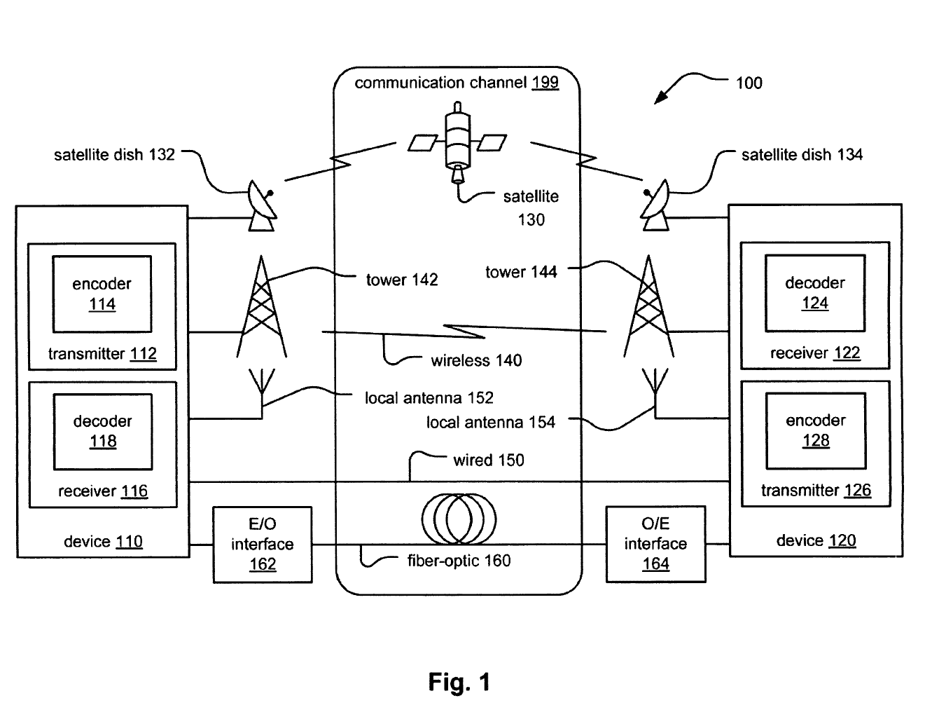

The goal of digital communications systems is to transmit digital data from one location, or subsystem, to another either error free or with an acceptably low error rate. As shown in FIG. 1, data may be transmitted over a variety of communications channels in a wide variety of communication systems: magnetic media, wired, wireless, fiber, copper, and other types of media as well.

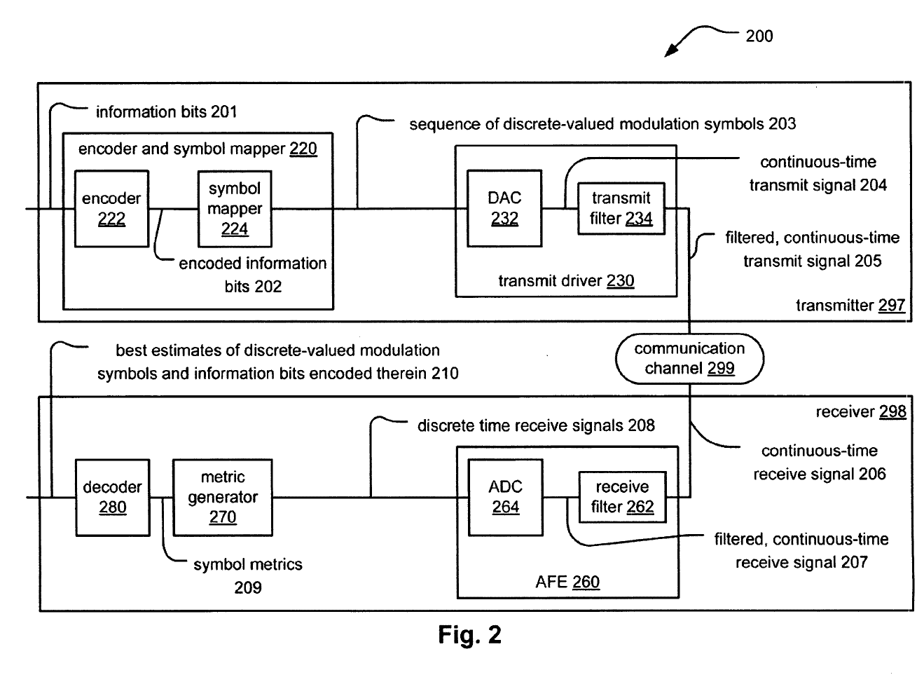

FIG. 1 and FIG. 2 are diagrams illustrate various embodiments of communication systems, 100 and 200, respectively.

Referring to FIG. 1, this embodiment of a communication system 100 is a communication channel 199 that communicatively couples a communication device 110 (including a transmitter 112 having an encoder 114 and including a receiver 116 having a decoder 118) situated at one end of the communication channel 199 to another communication device 120 (including a transmitter 126 having an encoder 128 and including a receiver 122 having a decoder 124) at the other end of the communication channel 199. In some embodiments, either of the communication devices 110 and 120 may only include a transmitter or a receiver. There are several different types of media by which the communication channel 199 may be implemented (e.g., a satellite communication channel 130 using satellite dishes 132 and 134, a wireless communication channel 140 using towers 142 and 144 and/or local antennae 152 and 154, a wired communication channel 150, and/or a fiber-optic communication channel 160 using electrical to optical (E/O) interface 162 and optical to electrical (O/E) interface 164)). In addition, more than one type of media may be implemented and interfaced together thereby forming the communication channel 199.

To reduce transmission errors that may undesirably be incurred within a communication system, error correction and channel coding schemes are often employed. Generally, these error correction and channel coding schemes involve the use of an encoder at the transmitter and a decoder at the receiver.

Referring to the communication system 200 of FIG. 2, at a transmitting end of a communication channel 299, information bits 201 are provided to a transmitter 297 that is operable to perform encoding of these information bits 201 using an encoder and symbol mapper 220 (which may be viewed as being distinct functional blocks 222 and 224, respectively) thereby generating a sequence of discrete-valued modulation symbols 203 that is provided to a transmit driver 230 that uses a DAC (Digital to Analog Converter) 232 to generate a continuous-time transmit signal 204 and a transmit filter 234 to generate a filtered, continuous-time transmit signal 205 that substantially comports with the communication channel 299. At a receiving end of the communication channel 299, continuous-time receive signal 206 is provided to an AFE (Analog Front End) 260 that includes a receive filter 262 (that generates a filtered, continuous-time receive signal 207) and an ADC (Analog to Digital Converter) 264 (that generates discrete-time receive signals 208). A metric generator 270 calculates symbol metrics 209 that are employed by a decoder 280 to make best estimates of the discrete-valued modulation symbols and information bits encoded therein 210.

The decoders of either of the previous embodiments may be implemented to include various aspects and/or embodiment of the invention therein. In addition, several of the following Figures describe other and particular embodiments (some in more detail) that may be used to support the devices, systems, functionality and/or methods that may be implemented in accordance with certain aspects and/or embodiments of the invention. One particular type of signal that is processed according to certain aspects and/or embodiments of the invention is an LDPC coded signal. Before more details are provided below, a general description of LDPC codes is provided.

Several of the following Figures describe other and particular embodiments (some in more detail) that may be used to support the devices, systems, functionality and/or methods that may be implemented in accordance with certain aspects and/or embodiments of the invention. One particular type of signal that is processed according to certain aspects and/or embodiments of the invention is an LDPC coded signal. Before more details are provided below, a general description of LDPC codes is provided.

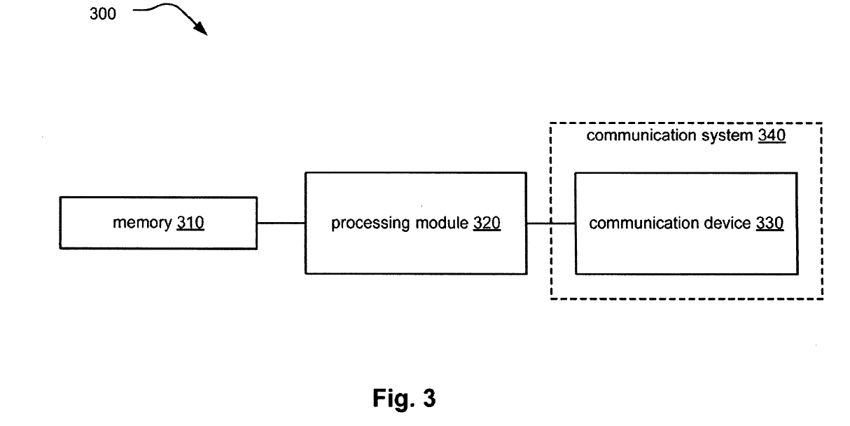

FIG. 3 illustrates an embodiment of an apparatus 300 that is operable to perform LDPC decoding processing. The apparatus 300 includes a processing module 320, and a memory 310. The memory 310 is coupled to the processing module, and the memory 310 is operable to store operational instructions that enable the processing module 320 to perform a variety of functions. The processing module 320 is operable to perform and/or direct the manner in which LDPC decoding processing is to be performed in accordance with any embodiment described herein, or any equivalent thereof.

The processing module 320 can be implemented using a shared processing device, individual processing devices, or a plurality of processing devices. Such a processing device may be a microprocessor, micro-controller, digital signal processor, microcomputer, central processing unit, field programmable gate array, programmable logic device, state machine, logic circuitry analog circuitry, digital circuitry and/or any device that manipulates signals (analog and/or digital) based on operational instructions. The memory 310 may be a single memory device or a plurality of memory devices. Such a memory device may be a read-only memory, random access memory, volatile memory, non-volatile memory, static memory, dynamic memory, flash memory, and/or any device that stores digital information. Note that when the processing module 320 implements one or more of its functions via a state machine, analog circuitry, digital circuitry, and/or logic circuitry, the memory storing the corresponding operational instructions is embedded with the circuitry comprising the state machine, analog circuitry, digital circuitry, and/or logic circuitry.

If desired in some embodiments, the manner in which the LDPC decoding processing is to be performed (e.g., the portion, module, and/or functional block that is moved from a check engine into a bit engine) can be provided from the apparatus 300 to a communication system 340 that is operable to employ and perform LDPC coding using a desired LDPC code. For example, information corresponding to the LDPC code being used (e.g., the parity check matrix of the LDPC code) can also be provided from the processing module 320 to any of a variety of communication devices 330 implemented within the communication system 340 as well. In addition, the manner in which such LDPC decoding is to be performed within any of a variety of communication devices 330 implemented within the communication system 340 can also be provided from the processing module 320.

If desired, the apparatus 320 can be designed to generate multiple means of performing LDPC decoding in accordance with multiple needs and/or desires as well. In some embodiments, the processing module 320 can selectively provide different information (e.g., corresponding to different LDPC codes, etc.) to different communication devices and/or communication systems. That way, different communication links between different communication devices can employ different LDPC codes and/or means by which to perform LDPC decoding. Clearly, the processing module 320 can also provide the same information to each of different communication devices and/or communication systems as well without departing from the scope and spirit of the invention.

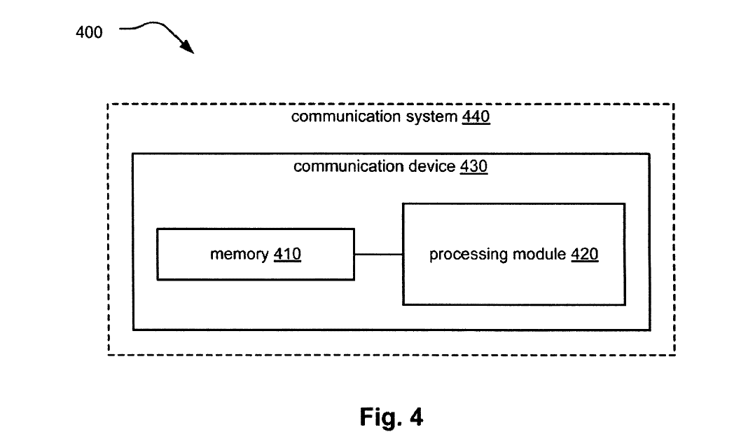

FIG. 4 illustrates an alternative embodiment of an apparatus 400 that is operable to perform LDPC decoding processing. The apparatus 400 includes a processing module 420, and a memory 410. The memory 410 is coupled to the processing module, and the memory 410 is operable to store operational instructions that enable the processing module 420 to perform a variety of functions. The processing module 420 (serviced by the memory 420) can be implemented as an apparatus capable to perform any of the functionality of any of the various modules and/or functional blocks described herein. For example, the processing module 420 (serviced by the memory 420) can be implemented as an apparatus capable to perform and/or direct the manner in which LDPC decoding processing is to be performed in accordance with any embodiment described herein, or any equivalent thereof.

The processing module 420 can be implemented using a shared processing device, individual processing devices, or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The memory 410 may be a single memory device or a plurality of memory devices. Such a memory device may be a read-only memory, random access memory, volatile memory, non-volatile memory, static memory, dynamic memory, flash memory, and/or any device that stores digital information. Note that when the processing module 420 implements one or more of its functions via a state machine, analog circuitry, digital circuitry, and/or logic circuitry, the memory storing the corresponding operational instructions is embedded with the circuitry comprising the state machine, analog circuitry, digital circuitry, and/or logic circuitry.

If desired in some embodiments, the apparatus 400 can be any of a variety of communication devices 430, or any part or portion of any such communication device 430. Any such communication device that includes the processing module 420 and/or memory 410 can be implemented within any of a variety of communication systems 440 as well. It is also noted that various embodiments of LDPC decoding processing in accordance with LDPC decoding processing as presented herein, and equivalents thereof, may be applied to many types of communication systems and/or communication devices.

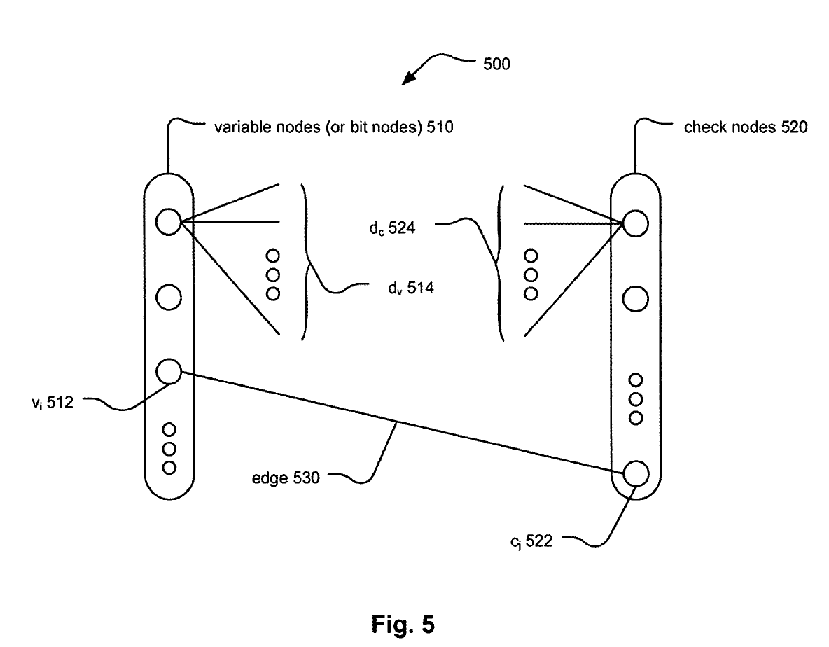

FIG. 5 illustrates an embodiment of an LDPC (Low Density Parity Check) code bipartite graph 500. In the art, an LDPC bipartite graph may also sometimes be referred to as a “Tanner” graph. An LDPC code may be viewed as being a code having a binary parity check matrix such that nearly all of the elements of the matrix have values of zeroes (e.g., the binary parity check matrix is sparse). For example, H=(h_{i, j})_{M×N} may be viewed as being a parity check matrix of an LDPC code with block length N.

LDPC codes are linear block codes and hence the set of all codewords xεC spans the null space of a parity check matrix, H.

Hx^{T}=0,∀xεC (1)

For LDPC codes, H, is a sparse binary matrix of dimension m×n. Each row of H corresponds to a parity check and a set element hᵢⱼ indicates that data symbol j participates in parity check i. Each column of H corresponds to a codeword symbol.

For each codeword x there are n symbols of which m are parity symbols. Hence the code rate r is given by:

r=(n−m)/n (2)

The row and column weights are defined as the number of set elements in a given row or column of H, respectively. The set elements of H are chosen to satisfy the performance requirements of the code. The number of 1's in the i-th column of the parity check matrix, H, may be denoted as dᵥ(i), and the number of 1's in the j-th row of the parity check matrix may be denoted as d_{c}(j). If dᵥ(i)=dᵥ for all i, and d_{c}(j)=d_{c} for all j, then the LDPC code is called a (dᵥ, d_{c}) regular LDPC code, otherwise the LDPC code is called an irregular LDPC code.

LDPC codes were introduced by R. Gallager in [1] referenced below (also in [2] referenced below) and by M. Luby et al. in [3] also referenced below.
[1] R. Gallager, Low-Density Parity-Check Codes, Cambridge, Mass.: MIT Press, 1963.
[2] R. G. Gallager, “Low density parity check codes,” IRE Trans. Info. Theory, vol. IT-8, January 1962, pp. 21-28.
[3] M. G. Luby, M. Mitzenmacher, M. A. Shokrollahi, D. A. Spielman, and V. Stemann, “Practical Loss-Resilient Codes”, Proc. 29^{th} Symp. on Theory of Computing, 1997, pp. 150-159.

A regular LDPC code can be represented as a bipartite graph 500 by its parity check matrix with left side nodes representing variable of the code bits (or alternatively as the “variable nodes” (or “bit nodes”) 510 in a bit decoding approach to decoding LDPC coded signals), and the right side nodes representing check equations (or alternatively as the “check nodes” 520). The bipartite graph 500 (or sometimes referred to as a Tanner graph 500) of the LDPC code defined by H may be defined by N variable nodes (e.g., N bit nodes) and M check nodes. Every variable node of the N variable nodes 510 has exactly dᵥ(i) edges (an example edge shown using reference numeral 530) connecting the bit node, vᵢ 512, to one or more of the check nodes (within the M check nodes). The edge 530 is specifically shown as connecting from the bit node, vᵢ 512, to the check node, cⱼ 522. This number of d, edges (shown as dᵥ 514) may be referred to as the degree of a variable node i. Analogously, every check node of the check nodes 520 has exactly d_{c}(j) edges (shown as d_{c} 524) connecting this node to one or more of the variable nodes (or bit nodes) 510. This number of edges, d_{c}, may be referred to as the degree of the check node j.

An edge 530 between a variable node vᵢ (or bit node bᵢ) 512 and check node cⱼ 522 may be defined by e=(i, j). However, on the other hand, given an edge e=(i, j), the nodes of the edge may alternatively be denoted as by e=(v(e), c(e)) (or e=(b(e), c(e))). Alternatively, the edges in the graph correspond to the set elements of H where a set element hⱼᵢ indicates that an edge connects a bit (e.g., variable) node i with parity check node j.

Given a variable node vᵢ (or bit node bᵢ), one may define the set of edges emitting from the node vᵢ (or bit node bᵢ) by Eᵥ(i)={e|v(e)=i} (or by E_{b}(i)={e|b(e)=i}); these edges are referred to as bit edges, and the messages corresponding to these bit edges are referred to as bit edge messages.

Given a check node cⱼ, one may define the set of edges emitting from the node cⱼ by E_{c}(j)={e|c(e)=j}; these edges are referred to as check edges, and the messages corresponding to these check edges are referred to as check edge messages. Continuing on, the derivative result will be |Eᵥ(i)|=dᵥ (or |E_{b}(i)=d_{b}) and |E_{c}(j)|=d_{c}.

Generally speaking, any codes that can be represented by a bipartite graph may be characterized as a graph code. It is also noted that an irregular LDPC code may also described using a bipartite graph. However, the degree of each set of nodes within an irregular LDPC code may be chosen according to some distribution. Therefore, for two different variable nodes, vᵢ_{₁} and vᵢ_{₂}, of an irregular LDPC code, |Eᵥ(i₁)| may not equal to |Eᵥ(i₂). This relationship may also hold true for two check nodes. The concept of irregular LDPC codes was originally introduced within M. Luby et al. in [3] referenced above.

In general, with a graph of an LDPC code, the parameters of an LDPC code can be defined by a degree of distribution, as described within M. Luby et al. in [3] referenced above and also within the following reference [4]:
[4] T. J. Richardson and R. L. Urbanke, “The capacity of low-density parity-check code under message-passing decoding,” IEEE Trans. Inform. Theory, Vol. 47, No. 2, February 2001, pp. 599-618.

This distribution may be described as follows:

Let λᵢ represent the fraction of edges emanating from variable nodes of degree and let ρᵢ represent the fraction of edges emanating from check nodes of degree i. Then, a degree distribution pair (λ, ρ) is defined as follows:

$$λ ( x ) = {\sum }_{i = 2}^{{M}_{v}} {λ}_{i} {x}^{i - 1} and ρ ( x ) = {\sum }_{i = 2}^{{M}_{c}} {ρ}_{i} {x}^{i - 1} ,$$

where Mᵥ and M_{c} represent the maximal degrees for variable nodes and check nodes, respectively.

While many of the illustrative embodiments described herein utilize regular LDPC code examples, it is noted that certain aspects and/or embodiments of the invention are also operable to accommodate both regular LDPC codes and irregular LDPC codes.

It is also noted that many of the embodiments described herein employ the terminology of “bit node” and “bit edge message”, or equivalents thereof. Oftentimes, in the art of LDPC decoding, the “bit node” and “bit edge message” are alternatively referred to as “variable node” and “variable edge message”, in that, the bit values (or variable values) are those which are attempted to be estimated. Either terminology can be employed in accordance with certain aspects of the invention.

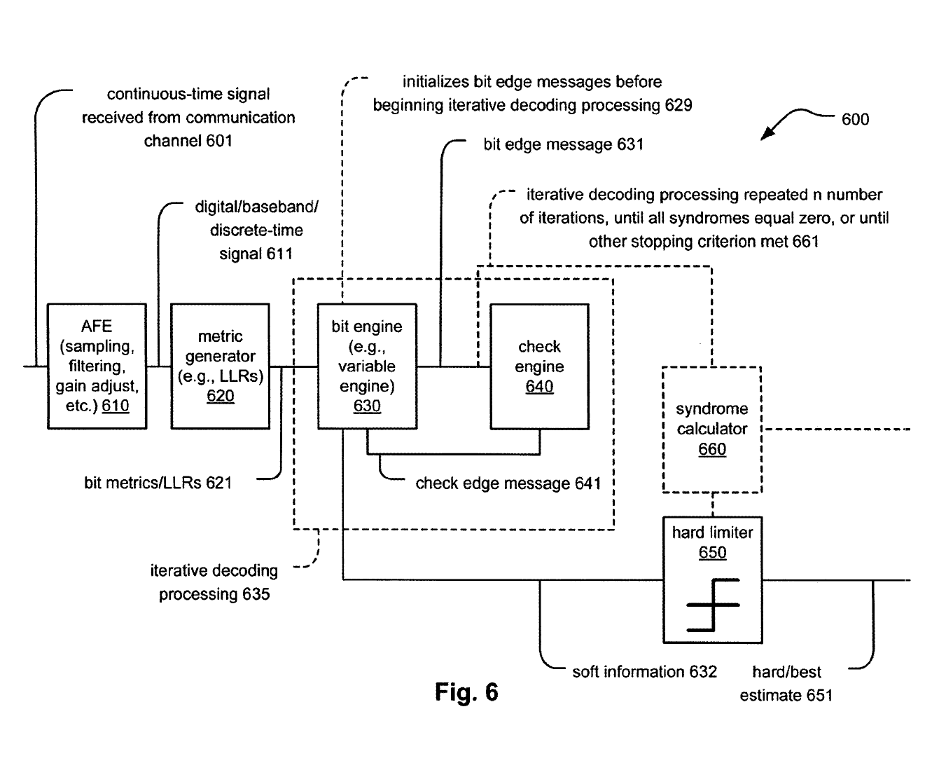

FIG. 6 illustrates an embodiment of LDPC decoding functionality 600. To perform decoding of an LDPC coded signal having an m-bit signal sequence, the functionality of this diagram may be employed. Generally speaking, a continuous-time signal is received from a communication channel, as shown by reference numeral 601. The communication channel can be any type of channel including, though not limited to, a wireline communication channel, a wireless communication channel, a fiber-optic communication channel, a read channel of a HDD, or other type of communication channel capable to carrying a continuous-time signal that has been coded using an LDPC code.

An analog front-end (AFE) 610 is operable to perform any initial processing on the continuous-time signal (e.g., by performing any one or more of filtering (analog and/or digital filtering), gain adjustment, etc.) and digital sampling thereby a discrete-time signal 611. This discrete-time signal 611 can alternatively be referred to as a digital signal, a baseband signal, or other appropriate terminology known in the art. Oftentimes, the discrete-time signal 611 is partitioned into I, Q (In-phase, Quadrature) values of the signal.

A metric generator 620 is operable to receive the discrete-time signal 611 (e.g., which can include the I, Q values thereof) and to calculate the corresponding bit metrics and/or log likelihood ratios (LLRs) 621 that correspond to the received values within the discrete-time signal 611. In some embodiments, the calculation of these bit metrics/LLRs symbol metrics 621 is a two-step process, in which, the metric generator 620 firstly is operable to calculate symbol metrics corresponding to the symbols of the discrete-time signal 611, an then the metric generator secondly is operable to employ the symbol metrics to decompose those symbol metrics into the bit metrics/LLRs 621. These bit metrics/LLRs 621 are then employed by a bit engine 630 to initialize the bit edge messages (e.g., as shown by reference numeral 629) that are employed when performing iterative decoding processing 635 (e.g., as performed by the bit engine 630 and a check engine 640) of the LDPC coded signal.

The initialization of the bit edge messages for each variable node i with the value of the log-likelihood ratio (LLR), λᵢ, of the corresponding received symbol, yᵢ, defined as follows:

$${λ}_{i} = ln [ \frac{Pr ( {x}_{i} = 0 \vert {y}_{i} )}{Pr ( {x}_{i} = 1 \vert {y}_{i} )} ] \qquad ( 3 )$$

Also, at the bit nodes, a bit engine 630 is operable to compute the corresponding soft information of the bits (e.g., shown as soft information 632) using the most recently updated bit edge messages. However, it is common for multiple decoding iterations to be performed, so the initialized bit edge messages are passed to the check engine 640 where, during a first decoding iteration, the check engine 640 is operable to employ the initialized bit edge messages to update check edge messages.

At each check node, the LDPC decoding processing forms a parity check result (XOR) on the sign of the incoming messages. This operates by finding the sign of each outgoing message as the XOR of the sign of the corresponding incoming message with the parity check result.

The decoding processing then calculates the outgoing message reliability from check node j to the bit (e.g., variable) node i according to:

$${λ}_{ji} = 2 {tanh}^{- 1} ( {\prod }_{k , {h}_{jk} = 1 , k \neq i} tanh ( \frac{{λ}_{jk}}{2} ) ) \qquad ( 4 )$$

In some desired embodiments, this calculation is performed in the log domain to transform the multiplication into a sum as follows:

$${λ}_{ji} = 2 {tanh}^{- 1} ( exp \{ {\sum }_{k , {h}_{jk} = 1 , k \neq i} log ( tanh ( \frac{{λ}_{jk}}{2} ) ) \} ) \qquad ( 5 )$$

Thereafter, the bit engine 630 is operable to receive the updated edge messages (e.g., shown as check edge message 641) from the check engine 640 and to employ them to update the bit edge messages. Also, the bit engine 630 is operable to employ the bit metrics/LLRs 621 that are received from the metric generator 620 when performing the updating of the bit edge messages in accordance with LDPC decoding. Also, these updated check edge messages 641 are then passed back to the bit nodes (e.g., to the bit engine 630) where the soft information 632 of the bits is calculated using the bit metrics/LLRs 621 and the current iteration values of the check edge messages. At each bit (e.g., variable) node, the calculation of the soft information involves forming the sum of the LLR of the received symbol with the incoming messages from the check node (e.g., the check edge messages 641). The decoded bit \hat{x}ᵢ is given by the sign of the summation. Each outgoing message for the next decoder iteration is computed by subtracting the corresponding incoming message from the summation. To continue with the iterative decoding processing 635, these bit edge messages 631, after being updated, are then passed to the check engine 640.

Another decoding iteration can be performed, in that, at the check nodes, the check engine 640 is then operable to receive these updated bit edge messages 631 sent from the bit nodes (e.g., from the bit engine 630) and updates the check edge messages accordingly. These updated check edge messages 641 are then passed back to the bit nodes (e.g., to the bit engine 630) where the soft information 632 of the bits is calculated using the bit metrics/LLRs 621 and the current iteration values of the check edge messages. Thereafter, using this just calculated soft information 632 of the bits, the bit engine 630 again is operable to update the bit edge messages using the previous values of the check edge messages (from the just previous iteration). The iterative processing 635 continues between the bit nodes and the check nodes according to the LDPC code bipartite graph that was employed to encode the signal that is being decoded.

These iterative decoding processing steps, performed by the bit node engine 630 and the check node engine 640, are repeated until a stopping criterion is met as shown by reference numeral 661 (e.g., after a predetermined or adaptively determined number of iterations have been performed, after all syndromes of the LDPC code are all equal to zero (e.g., all of the parity checks are satisfied), and/or other stopping criterion has been met). Another possible means by which LDPC decoding can be stopped is when the current estimate of the LDPC codeword, \hat{x}, satisfies the following relationship:

H\hat{x}^{T}=0

Soft information 632 can be generated within the bit engine 630 during each of the decoding iterations. In this embodiment, this soft information 632 may be provided to a hard limiter 650 where hard decisions may be made, and that hard information (e.g., hard/best estimate 651) may be provided to a syndrome calculator 660 that is operable to determine whether the syndromes of the LDPC code are all equal to zero. That is to say, the syndrome calculator 660 is operable to determine whether each syndrome associated with the LDPC code is equal to zero, based on the current estimate of the LDPC codeword.

When the syndromes are not equal to zero, the iterative decoding processing 635 can continue again by appropriately updating and passing the bit edge messages and the check edge messages between the bit engine 630 and the check engine 640, respectively. After all of these iterative decoding processing steps have been performed, then the hard/best estimates 651 of the bits are output based on the soft information 632.

Also, it is noted that for good decoding performance, it is important that the lengths of cycles in the graph are as long as possible. Short cycles, such as the length 4 cycle, can possibly degrade the performance of the message passing decoding approach to decoding an LDPC coded signal.

While the mathematics of the message passing decoding approach contains hyperbolic and logarithmic functions (e.g., see equation (5) above), in a hardware implementation these functions can alternatively be approximated by look-up tables (LUTs) or directly instantiated in logic gates. The arithmetic computation involves only additions, subtractions, and XOR operations. The number of bits required in fixed point implementation is determined by the required coding performance, speed of decoder convergence, and whether an error floor must be suppressed as described in reference [5].
[5] Zhang, T., Wang, Z., and Parhi, K., “On finite precision implementation of low density parity check codes decoder,” Proceedings of ISCAS, Sydney, Australia, May 2001, pp 202-205.

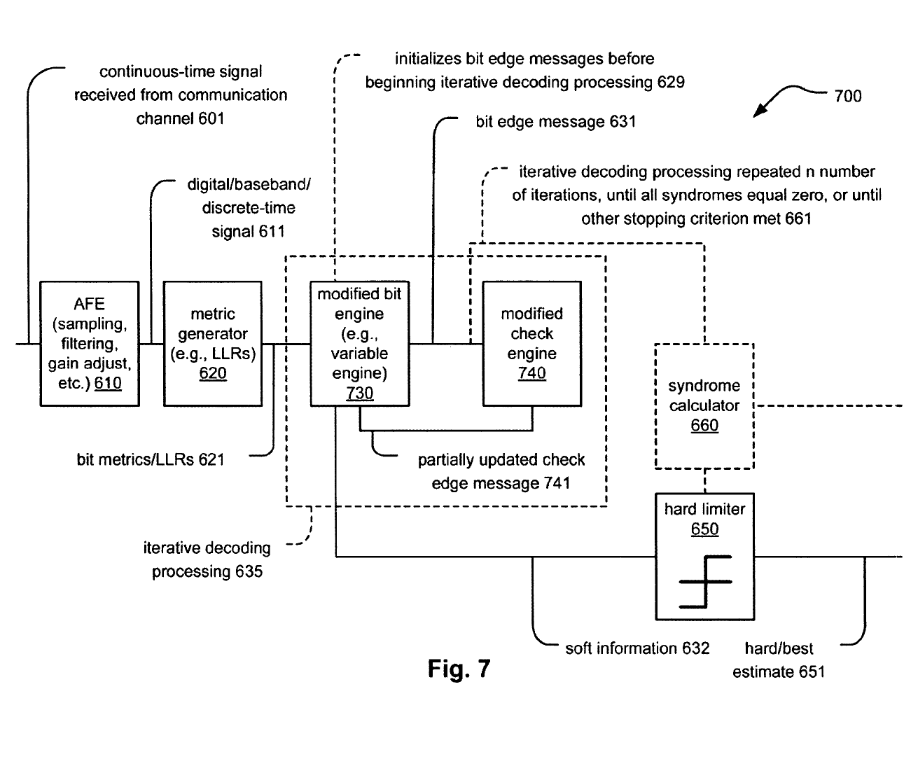

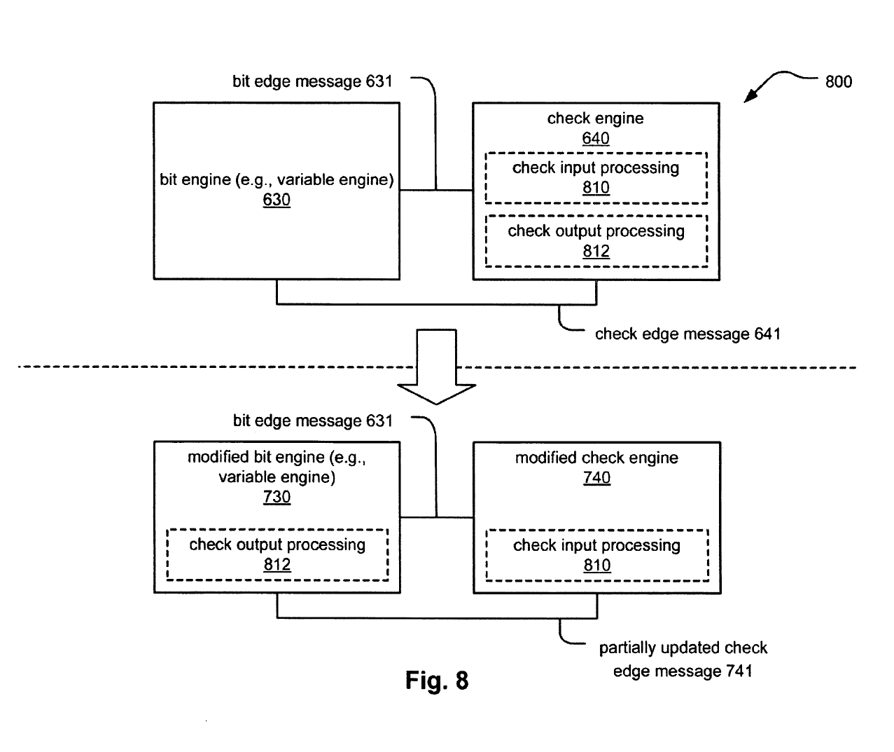

FIG. 7 illustrates an alternative embodiment of LDPC decoding functionality 700. This embodiment is somewhat analogous to the previous embodiment of FIG. 6, with at least one difference being that this embodiment includes a modified check engine 740 and a modified bit engine 730. At least one portion of the functionality of the check engine 640 of the FIG. 6 is transferred into the modified bit engine 730 thereby generating the modified check engine 740 of the FIG. 7. The modified bit engine 730 then includes the at least one portion of the functionality of the check engine 640 of the FIG. 6 that was transferred therein.

The modified check engine 740 is operable to generate only a partially updated check edge message 741. In alternatively embodiments, only a parity check result and a check sum compose the partially updated check edge message 741 that is generated within the modified check engine 740 and transferred to the modified bit engine 730.

The completion of the updating of the partially updated check edge message 741 is inherently performed during the sub-iteration bit node processing within the modified bit engine 730. It is noted that the transferring of the at least one portion of check engine functionality is performed in such a way that it is integrated into the modified bit engine 730.

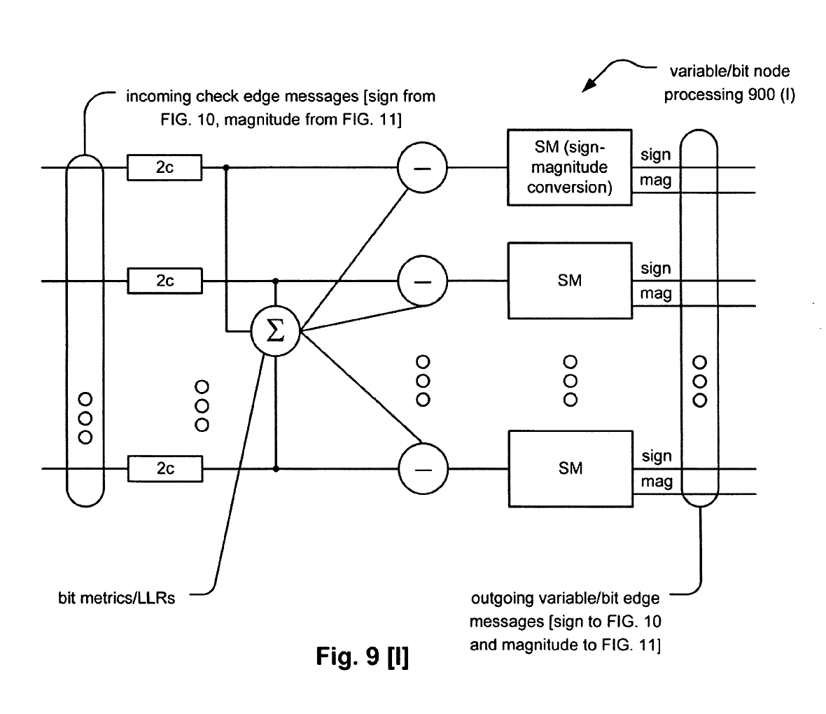

FIG. 8 illustrates relationships 800 between the bit engines and check engines of the FIG. 6 and FIG. 7. This diagram provides in perhaps greater detail for the reader the means by which at least one portion of check engine functionality is transferred from a check engine to a bit engine.

In this embodiment, a check engine 640, as in FIG. 6, include both check input processing functionality 810 and check output processing functionality 812. The check output processing functionality 812 is transferred from the check engine 640 into the modified bit engine 730. The resulting, modified check engine 740 still includes the check input processing functionality 810, by which the partially updated check edge message 741 is generated.

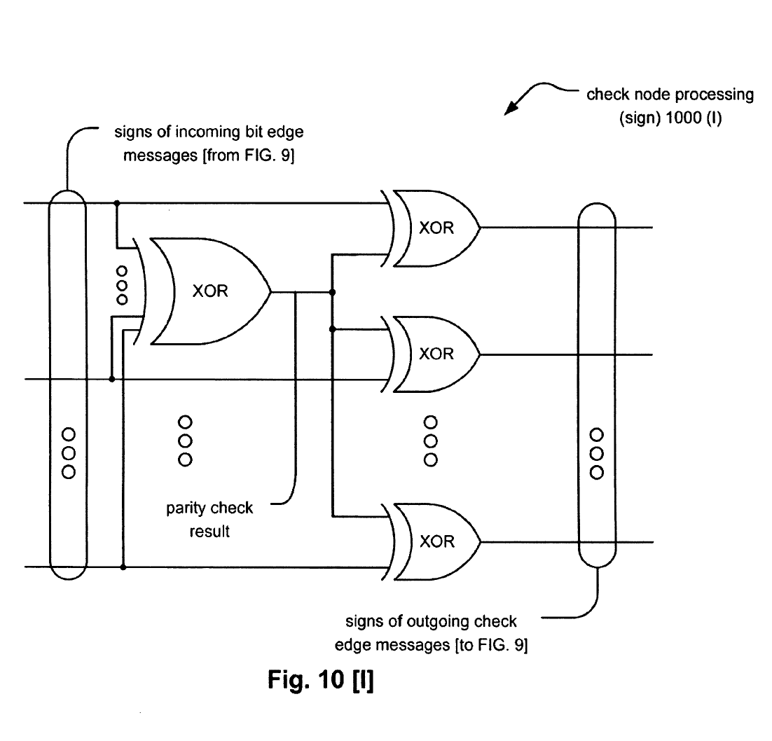

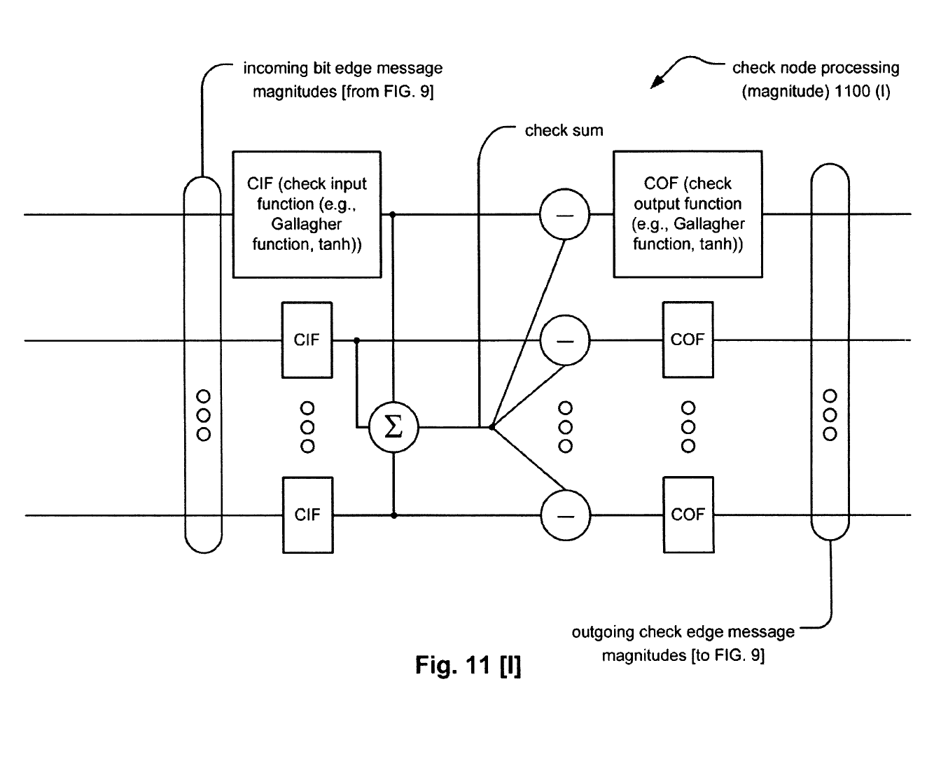

FIG. 9, FIG. 10, and FIG. 11 operate in conjunction with one another in embodiment [I].

FIG. 9 illustrates an embodiment of variable/bit node processing in accordance with LDPC decoding functionality.

Referring the FIG. 9, incoming bit edge messages are provided to a plurality of 2's complement processing modules; the 2's complement processing modules are operable to perform 2's complement conversion of the incoming check edge messages [the sign is provided from FIG. 10, and the magnitude is provided from FIG. 11]. Thereafter, the now-2's complement-converted incoming check edge messages are each passed to a summation module that also adds the appropriate bit metrics/LLRs corresponding to the received signal. Once the sum result is generated, to update each individual bit edge message, that respective check edge message is subtracted from the sum result using a corresponding subtractor. Thereafter, a plurality of sign-magnitude conversion modules (SMs) then generates the outgoing variable/bit edge messages that may be used for subsequent check node processing. These are shown as the outgoing variable/bit edge messages of which the signs are passed to FIG. 10 and the magnitudes are passed to FIG. 11.

FIG. 10 illustrates an embodiment of check node processing (sign) in accordance with LDPC decoding functionality.

Referring the FIG. 10, as also described above, when performing check node processing, at each check node, the LDPC decoding processing forms a parity check result (XOR) on the sign of the incoming bit edge messages [shown as being provided from FIG. 9]. This operates by finding the sign of each outgoing check message as the XOR of the sign of the corresponding incoming message with the parity check result, and the signs of the outgoing check edge messages are provided to FIG. 9.

FIG. 11 illustrates an embodiment of check node processing (magnitude) in accordance with LDPC decoding functionality.

Referring the FIG. 11, using incoming bit edge message magnitudes [from FIG. 9], the decoding processing then calculates the outgoing message reliability (e.g., outgoing check edge message magnitudes) from check node j to the bit (e.g., variable) node i according to:

$${λ}_{ji} = 2 {tanh}^{- 1} ( {\prod }_{k , {h}_{jk} = 1 , k \neq i} tanh ( \frac{{λ}_{jk}}{2} ) ) \qquad ( 4 )$$

In some desired embodiments, this calculation is performed in the log domain to transform the multiplication into a sum as follows:

$${λ}_{ji} = 2 {tanh}^{- 1} ( exp \{ {\sum }_{k , {h}_{jk} = 1 , k \neq i} log ( tanh ( \frac{{λ}_{jk}}{2} ) ) \} ) \qquad ( 5 )$$

The equations (4) and (5), also depicted above, are sometimes described as “Gallagher functions”, hyperbolic tangent functions “tan h”, etc. As referred to herein, “check input functions” (CIFs) and “check output functions” (COFs) are employed in accordance with LDPC decoding processing, and each can be viewed as being part of equation (5) in the log domain implementation.

For example,

$${λ}_{ji} = 2 {tanh}^{- 1} ( exp \{ {\sum }_{k , {h}_{jk} = 1 , k \neq i} log ( tanh ( \frac{{λ}_{jk}}{2} ) ) \} ) = COF ( Σ \{ CIF \} ) \qquad ( 6 )$$

where,

a. “check input function” (CIF): y=log(tan h(x/2))

b. “check output function” (COF): y=2(tan h⁻¹(exp(x))), where tan h⁻¹ is the hyperbolic arctangent (i.e., arctan h).

A check sum is calculated by adding all of the outputs of the “echeck input functions” (e.g., CIF modules), after receiving and processing the incoming bit edge message magnitudes [from the FIG. 9]. Thereafter, the magnitude of each check edge message is subtracted from the check sum result to generate a result that subsequently undergoes processing within a corresponding “check output function” (COF), the output of which is then provides as an updated/outgoing check edge message; all of the updated/outgoing check edge messages are corporately depicted as being provided to FIG. 9.

It is noted that certain embodiments included herein depict embodiments in which portions of functionality are transferred from check node processing functionality into variable/bit node processing functionality. It is also noted that certain embodiments included herein depict embodiments in which portions of functionality are transferred from variable/bit node processing into check node processing. The transference of functionality can be performed in either direction, or in both directions.

Moreover, alternative embodiments can also be implemented without departing from the scope and spirit of the invention, in that, more or less functionality can be transferred from one module (e.g., from a check node processing module) to another module (e.g., to a bit node processing module) as desired in a given application.

For example, the moving of variable/bit node output processing to the input of the check node processing can be performed to provide for improvements over the prior art including reduced interconnection complexity.

Moreover, doing transferring of BOTH some functionality from a bit node processing module to a check node processing module AND also performing transferring of some functionality from a check node processing module to a bit node processing module (e.g., or vice versa) can also be performed to provide for improvements over the prior art including reduced interconnection complexity.

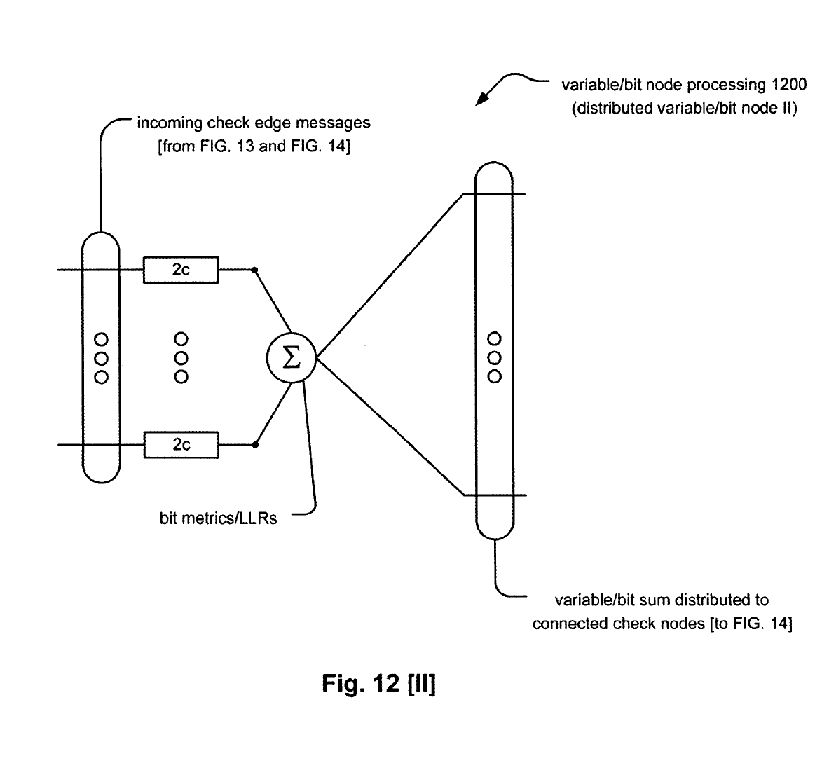

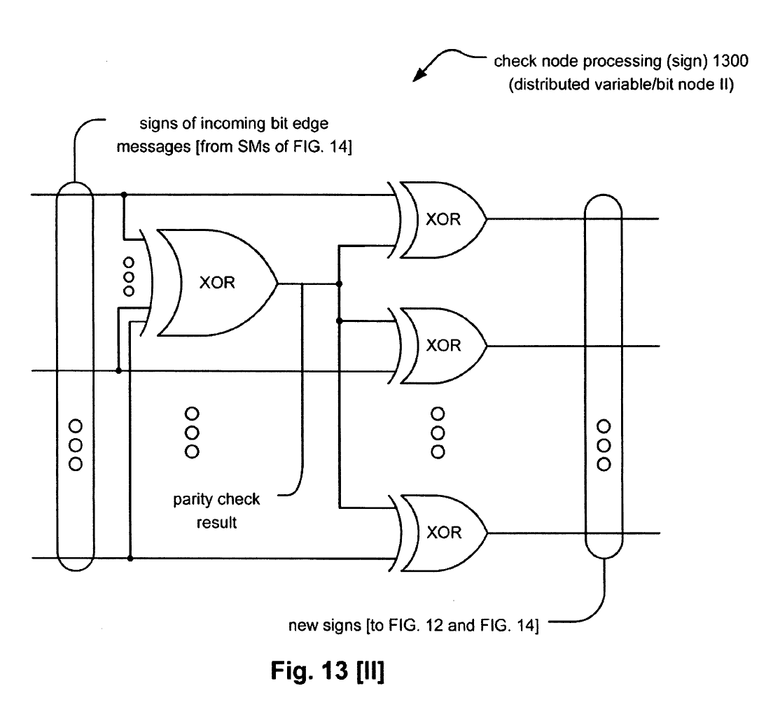

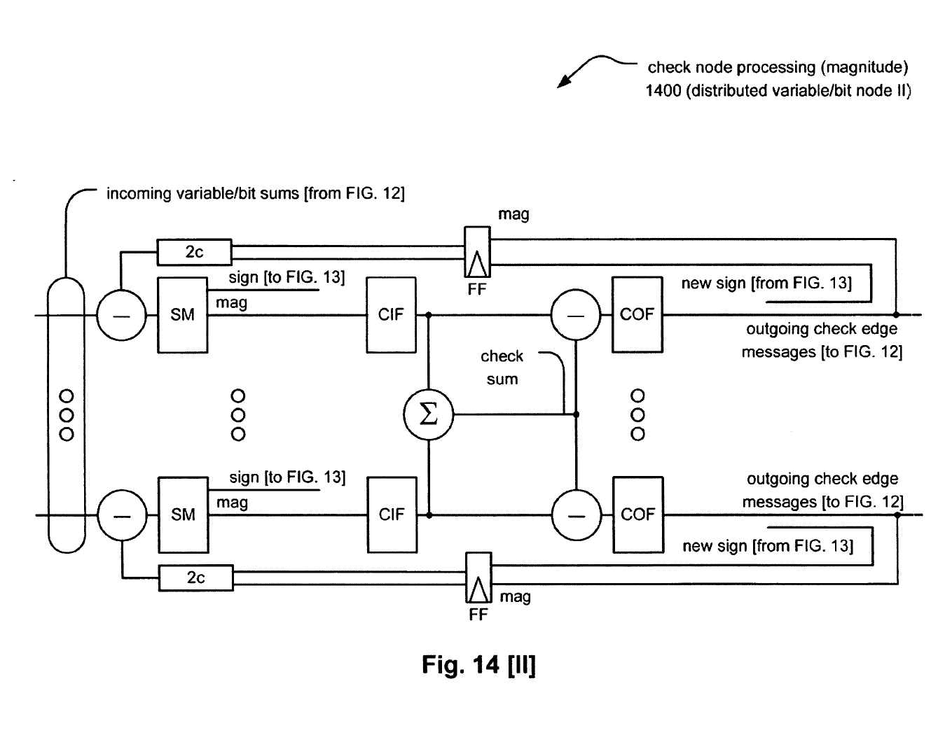

FIG. 12, FIG. 13, and FIG. 14 operate in conjunction with one another in embodiment [II] which employs a distributed variable/bit node architecture. In these diagrams, it can be seen how some functionality from variable/bit node processing can be moved into functionality of the check node processing.

FIG. 12 illustrates an embodiment of variable/bit node processing in accordance with LDPC decoding functionality of embodiment [II].

Referring the FIG. 12, in this embodiment, incoming check edge messages [from FIG. 13 and FIG. 14] are provided to a plurality of 2's complement processing modules; the 2's complement processing modules are operable to perform 2's complement conversion of the incoming check edge messages. Thereafter, the now-2's complement-converted incoming check edge messages are each passed to a summation module that also adds the appropriate bit metrics/LLRs corresponding to the received signal. Once the variable/bit sum result is generated, it is distributed to the connected check nodes [to the FIG. 14] for use in subsequent distributed check node processing.

FIG. 13 illustrates an embodiment of check node processing (sign) in accordance with LDPC decoding functionality of embodiment [II].

Referring the FIG. 13, it is noted that this sign check node processing is somewhat similar to that embodiment depicted in FIG. 10; there are some differences, however. When performing check node processing in this embodiment, at each check node, the LDPC decoding processing forms a parity check result (XOR) on the signs of incoming bit edge messages [from the SMs of FIG. 14]. This operates by finding the new signs [to be sent to FIG. 12 and FIG. 14] as the XOR of the sign of the corresponding incoming message with the parity check result.

FIG. 14 illustrates an embodiment of check node processing (magnitude) in accordance with LDPC decoding functionality of embodiment [II].

Referring the FIG. 14, the incoming variable/bit sums [from the FIG. 12] are provided to a plurality of subtractors. The corresponding other one of two inputs that is provided to each of the plurality of subtractors is an output of a 2's complement conversion module.

The output of each subtractor is provided to a corresponding SM module from which a sign and magnitude (depicted as “mag” in the diagram) are output. The sign output from the SM module is provided to the FIG. 13 and is operable to undergo updating within FIG. 13. The magnitude output from each SM module is passed to a corresponding CIF module.

A check sum is calculated by adding all of the outputs of the “check input functions” (e.g., CIF modules). Thereafter, the magnitude of each check edge message is subtracted from the check sum result to generate a result that subsequently undergoes processing within a corresponding “check output function” (COF), the output of which is then fed back to a flip-flop (FF) (along a the new sign value that has been generated within FIG. 13), and the outputs (sign and magnitude) of the flip-flop (FF) are provided to the corresponding 2's complement conversion module.

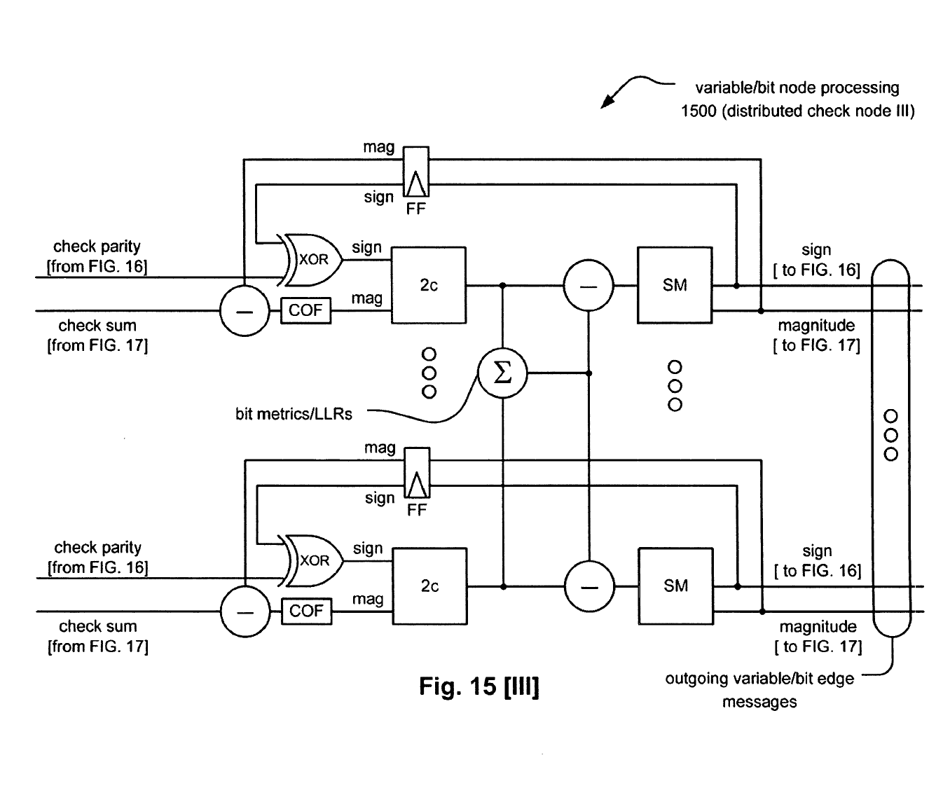

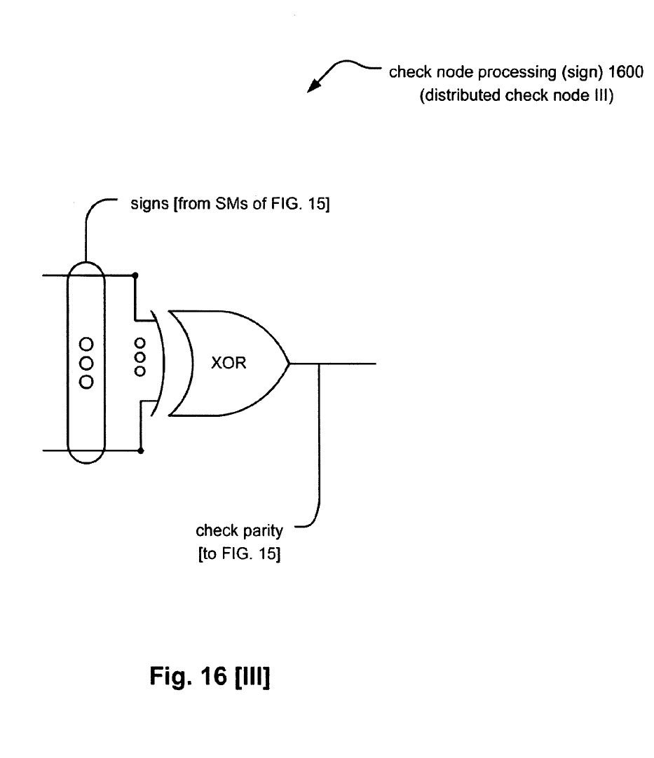

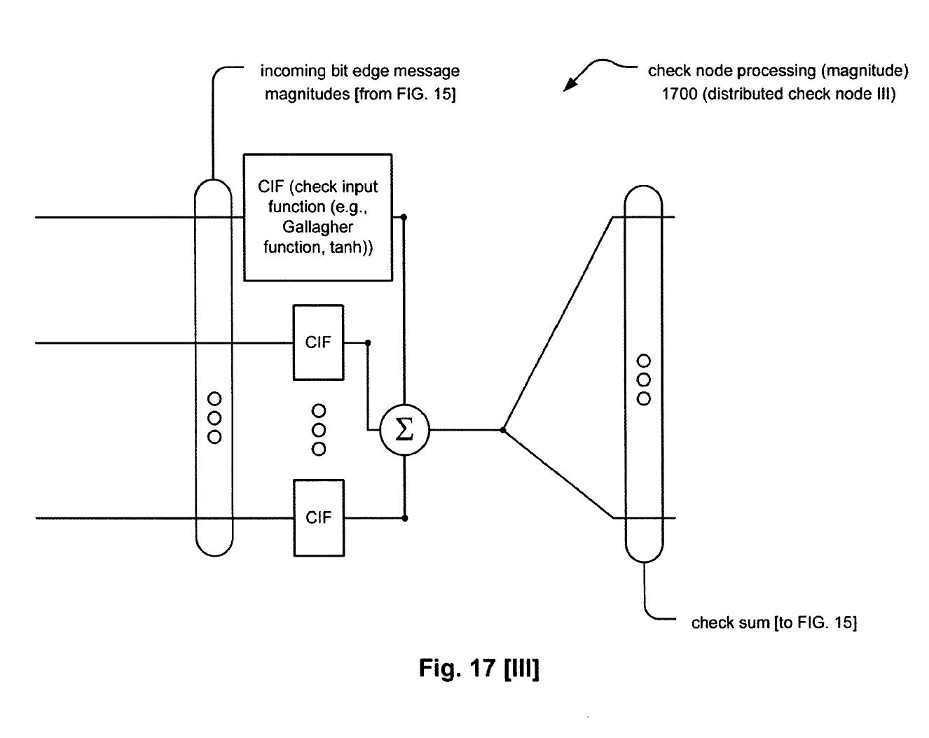

FIG. 15, FIG. 16, and FIG. 17 operate in conjunction with one another in embodiment [III] which employs a distributed check node architecture. In these diagrams, it can be seen how some functionality from check node processing can be moved into functionality of the variable/bit node processing.

FIG. 15 illustrates an embodiment of variable/bit node processing in accordance with LDPC decoding functionality of embodiment [III].

Referring the FIG. 15, check parities [from FIG. 16] and check sums [from FIG. 17] are input on the left hand side of the diagram. The check sums [from FIG. 17] are provided to each of a plurality of subtractors and the corresponding other one of two inputs that is provided to each of the plurality of subtractors is the magnitude output of a flip-flop (FF). The check parities [from FIG. 16] are provided to each of a plurality of XOR modules and the corresponding other one of two inputs that is provided to each of the plurality of XOR modules is the sign output of the flip-flop (FF). The output from each XOR module is then provided to a 2's complement conversion module. The output from each subtractor is provided to a corresponding “check output function” (COF), the output of which is then also provided to the 2's complement conversion module.

Thereafter, the now-2's complement-converted incoming bit edge messages are each passed to a summation module that also adds the appropriate bit metrics/LLRs corresponding to the received signal. Once the sum result is generated, to update each individual bit edge message, that respective check edge message is subtracted from the sum result using a corresponding subtractor. Thereafter, a plurality of sign-magnitude conversion modules (SMs) then generate the outgoing variable/bit edge messages that may be used for subsequent check node processing [the sign of which is provided to FIG. 16, and the magnitude of which is provided to FIG. 17]. In addition, the sign output and the magnitude output from each of the corresponding SMs is fed back to the flip-flop (FF) whose outputs are passed to the corresponding XOR modules (whose other input is the check parity from FIG. 16) as the subtractors that also (whose other input is the check sum from FIG. 17).

FIG. 16 illustrates an embodiment of check node processing (sign) in accordance with LDPC decoding functionality of embodiment [III].

Referring the FIG. 16, when performing check node processing in this embodiment, at each check node, the LDPC decoding processing forms a parity check result (XOR) on the signs of incoming bit edge messages [from the SMs of FIG. 15]. The check parity value is passed to the FIG. 15.

FIG. 17 illustrates an embodiment of check node processing (magnitude) in accordance with LDPC decoding functionality of embodiment [III].

Referring the FIG. 17, using incoming bit edge message magnitudes [from FIG. 15], the decoding processing then calculates the outgoing message reliability (e.g., outgoing check edge message magnitudes) from check node j to the bit (e.g., variable) node i according to the “check input functions” (CIFs) (or alternatively as “Gallagher functions”, hyperbolic tangent functions “tan h”, etc.) as also described above.

A check sum is calculated by adding all of the outputs of the “check input functions” (e.g., CIF modules), after receiving and processing the incoming bit edge message magnitudes [from FIG. 15]. This check sum is broadcast to each of the connected variable/bit nodes as depicted in FIG. 15.

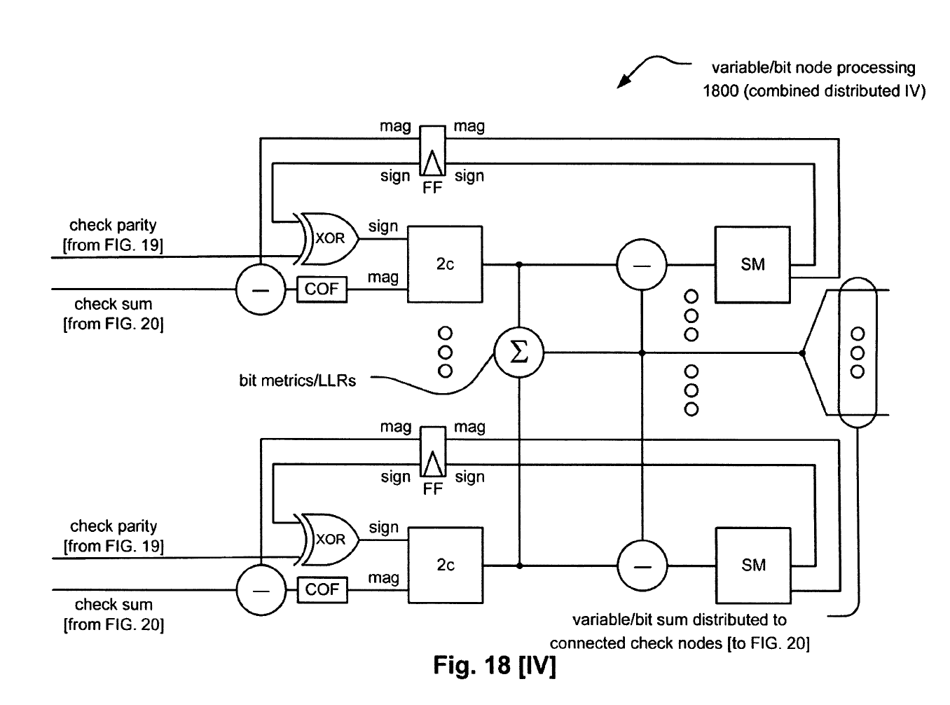

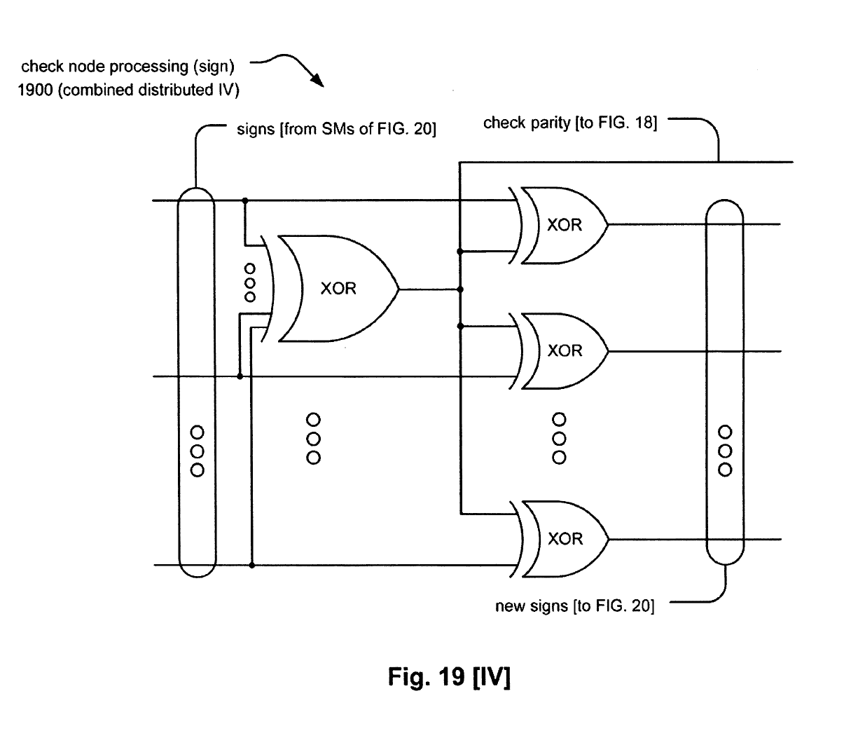

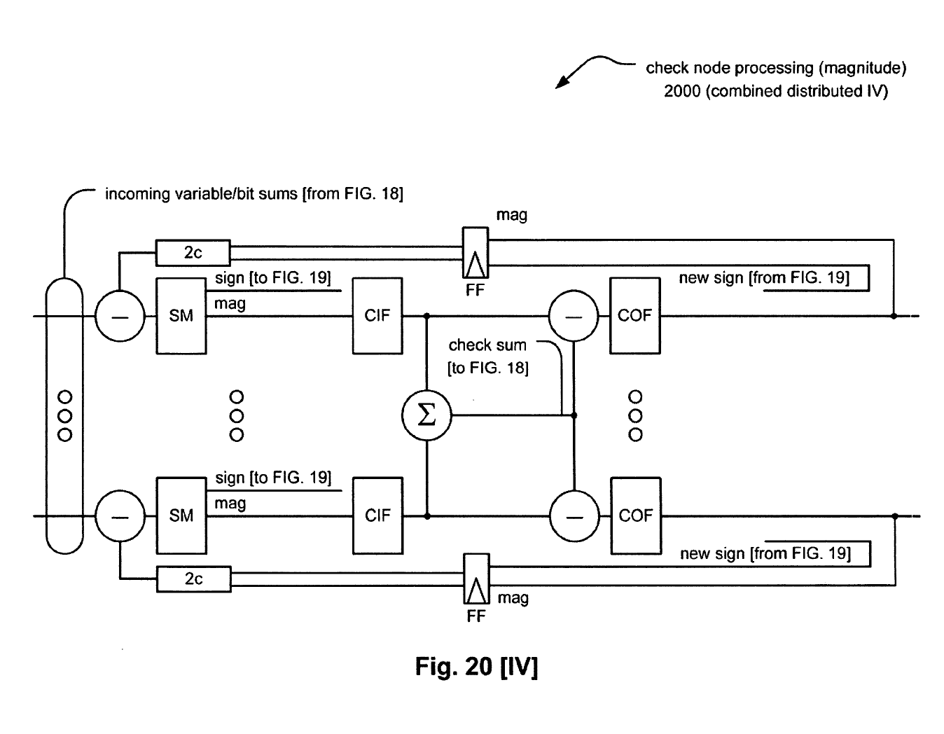

FIG. 18, FIG. 19, and FIG. 20 operate in conjunction with one another in embodiment [IV] which employs a combined distributed variable/bit node and check node architecture. In these diagrams, it can be seen how some functionality from check node processing can be moved into functionality of the variable/bit node processing, and some functionality from variable/bit node processing can be moved into functionality of the check node processing. In other words, by being a “combined” embodiment, some functionality is transferred in both directions.

FIG. 18 illustrates an embodiment of variable/bit node processing in accordance with LDPC decoding functionality of embodiment [IV].

Referring the FIG. 18, check parities [from FIG. 19] and check sums [from FIG. 20] are input on the left hand side of the diagram. The check sums [from FIG. 20] are provided to each of a plurality of subtractors and the corresponding other one of two inputs that is provided to each of the plurality of subtractors is the magnitude output of a flip-flop (FF). The check parities [from FIG. 19] are provided to each of a plurality of XOR modules and the corresponding other one of two inputs that is provided to each of the plurality of XOR modules is the sign output of the flip-flop (FF). The output from each XOR module is then provided to a 2's complement conversion module. The output from each subtractor is provided to a corresponding “check output function” (COF), the output of which is then also provided to the 2's complement conversion module.

Thereafter, the now-2's complement-converted incoming bit edge messages are each passed to a summation module that also adds the appropriate bit metrics/LLRs corresponding to the received signal. Once the sum result is generated, to update each individual bit edge message, that respective check edge message is subtracted from the sum result using a corresponding subtractor. Also, the variable/bit sum is distributed to the connected check nodes as depicted in FIG. 20.

Also, a plurality of sign-magnitude conversion modules (SMs) then generates the outgoing variable/bit edge messages; the sign output and the magnitude output from each of the corresponding SMs is fed back to the flip-flop (FF) whose outputs are passed to the corresponding XOR modules (whose other input is the check parity from FIG. 19) and the subtractors that also (whose other input is the check sum from FIG. 20).

FIG. 19 illustrates an embodiment of check node processing (sign) in accordance with LDPC decoding functionality of embodiment [IV].

Referring the FIG. 19, when performing check node processing in this embodiment, at each check node, the LDPC decoding processing forms a parity check result (XOR) on the signs of signs [from the SMs of FIG. 20]. The check parity result is passed to the FIG. 18. In addition, this embodiment operates by finding the new signs [to be sent to FIG. 20] as the XOR of the sign of the corresponding incoming sign [from the SMs of FIG. 20] with the parity check result.

FIG. 20 illustrates an embodiment of check node processing (magnitude) in accordance with LDPC decoding functionality of embodiment [IV].

Referring the FIG. 20, the incoming variable/bit sums [from the FIG. 18] are provided to a plurality of subtractors. The corresponding other one of two inputs that is provided to each of the plurality of subtractors is an output of a 2's complement conversion module.

The output of each subtractor is provided to a corresponding SM module from which a sign and magnitude (depicted as “mag” in the diagram) are output. The sign output from the SM module is provided to the FIG. 19 and is operable to undergo updating within FIG. 19. The magnitude output from each SM module is passed to a corresponding CIF module.

A check sum is calculated by adding all of the outputs of the “check input functions” (e.g., CIF modules). This check sum is provided to the FIG. 18. Thereafter, the magnitude of each check edge message is subtracted from the check sum result to generate a result that subsequently undergoes processing within a corresponding “check output function” (COF), the output of which is then fed back to a flip-flop (FF) (along a the new sign value that has been generated within FIG. 19), and the outputs (sign and magnitude) of the flip-flop (FF) are provided to the corresponding 2's complement conversion module.

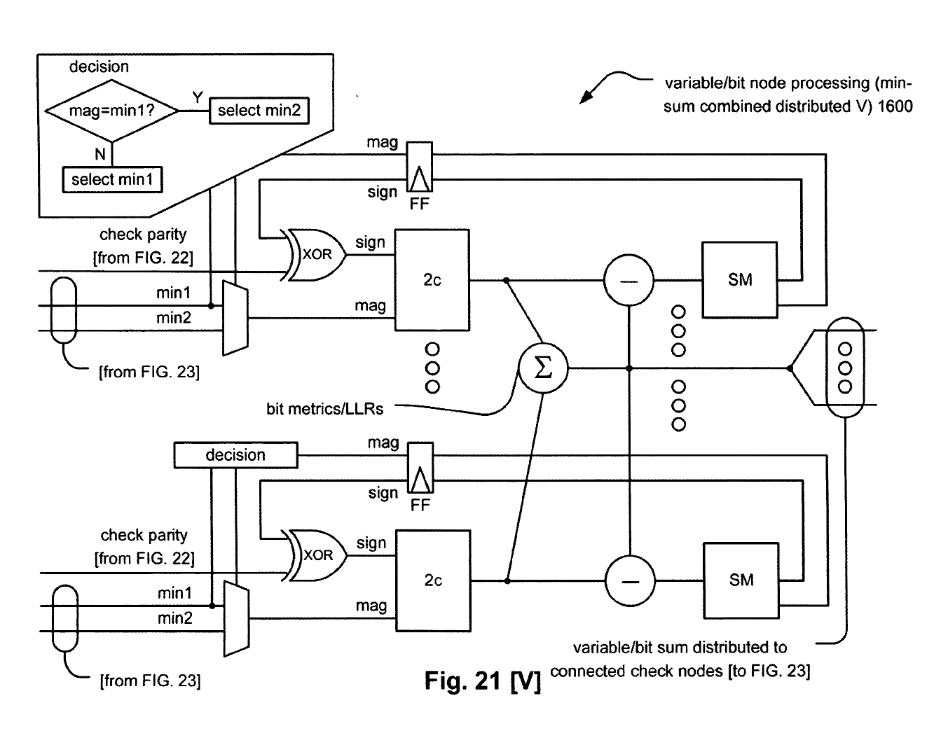

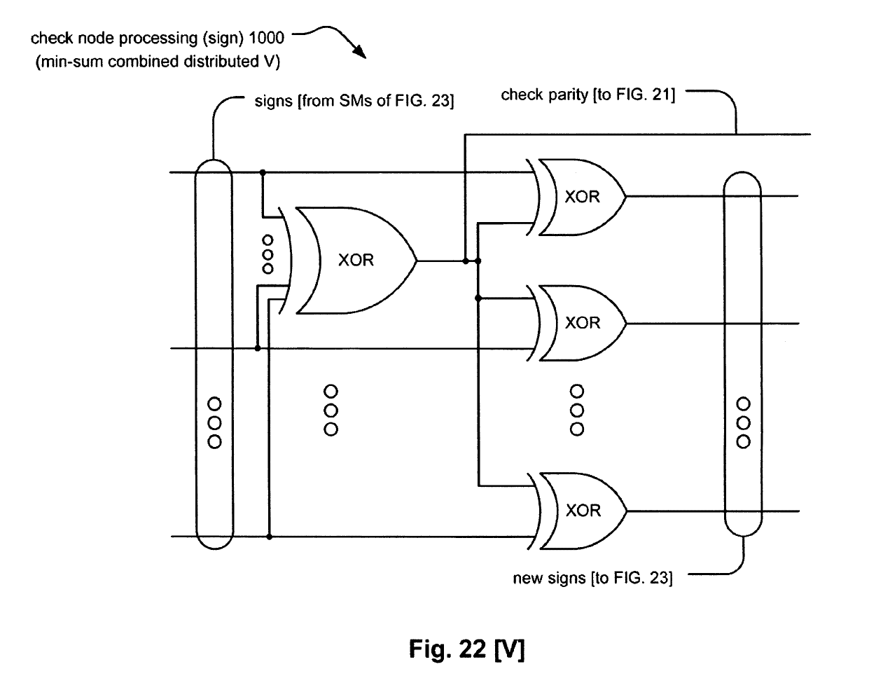

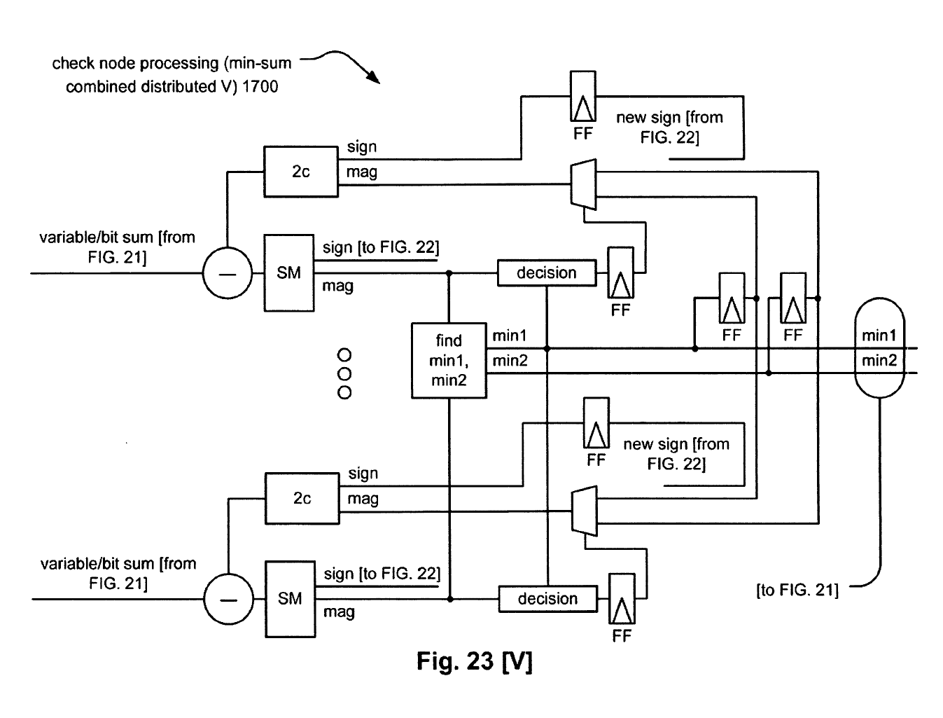

FIG. 21, FIG. 22, and FIG. 23 operate in conjunction with one another in embodiment [IV] which employs a min-sum combined distributed variable/bit node and check node architecture.

FIG. 21 illustrates an embodiment of variable/bit node processing in accordance with LDPC decoding functionality of embodiment [V].

Referring the FIG. 21, check parities [from FIG. 22] and min1 and min2 values [from FIG. 23] are input on the left hand side of the diagram. The min1 and min2 values [from FIG. 23] are provided to each of a plurality of multiplexers (MUXs) and the min1 inputs are each also provided to a plurality of decision modules. Each of the decision module is operable to perform the selection of which of min1 and min2 (that are input to that corresponding MUX) are to be output from the corresponding MUX and then provided to a 2's complement conversion module.

The check parities [from FIG. 22] are provided to each of a plurality of XOR modules and the corresponding other one of two inputs that is provided to each of the plurality of XOR modules is the sign output of a corresponding flip-flop (FF). The output from each XOR module is then provided to the 2's complement conversion module.

Thereafter, the now-2's complement-converted incoming bit edge messages are each passed to a summation module that also adds the appropriate bit metrics/LLRs corresponding to the received signal. Once the sum result is generated, to update each individual bit edge message, that respective check edge message is subtracted from the sum result using a corresponding subtractor. Also, the variable/bit sum is distributed to the connected check nodes as depicted in FIG. 23.

Also, a plurality of sign-magnitude conversion modules (SMs) then generates the outgoing variable/bit edge messages; the sign output and the magnitude output from each of the corresponding SMs is fed back to the flip-flop (FF) whose outputs are passed to the corresponding XOR modules (whose other input is the check parity from FIG. 19) and the decision modules.

Each decision module is operable to determine whether the magnitude Image value output from the flip-flop (FF) is the same value as the min1 that is from FIG. 23. If yes, then the corresponding MUX selects min2 to be provided to the corresponding 2's complement conversion module. If no, then the corresponding MUX selects min1 to be provided to the corresponding 2's complement conversion module. This decision making is also employed within other embodiments depicted herein.

FIG. 22 illustrates an embodiment of check node processing (sign) in accordance with LDPC decoding functionality of embodiment [V].

Referring the FIG. 22, when performing check node processing in this embodiment, at each check node, the LDPC decoding processing forms a parity check result (XOR) on the signs of signs [from the SMs of FIG. 23]. The check parity result is passed to the FIG. 21. In addition, this embodiment operates by finding the new signs [to be sent to FIG. 23] as the XOR of the sign of the corresponding incoming sign [from the SMs of FIG. 23] with the parity check result.

FIG. 23 illustrates an embodiment of check node processing (magnitude) in accordance with LDPC decoding functionality of embodiment [V].

Referring the FIG. 23, the incoming variable/bit sums [from the FIG. 21] are provided to a plurality of subtractors. The corresponding other one of two inputs that is provided to each of the plurality of subtractors is an output of a 2's complement conversion module.

The output of each subtractor is provided to a corresponding SM module from which a sign and magnitude (depicted as “mag” in the diagram) are output. The sign output from the SM module is provided to the FIG. 22 and is operable to undergo updating within FIG. 22. The magnitude output from each SM module is passed to both a corresponding decision module and also to a find min1, min2 module. The find min1, min2 module is operable to identify the minimum and the 2^{nd} to least minimum among all of the magnitudes “mags” provided thereto from the plurality of SM modules. The minimum (min1) output from the find min1, min2 module is also provided to each of the plurality of decision modules. The found min1 and min2 values are then passed to FIG. 21, and the found min1 and min2 values are also passed via two separate flip-flops (FFs) before being fed back as the two inputs to a plurality of corresponding MUXs.

Each decision module is operable to determine whether the magnitude “mag” value output from the corresponding SM module is the same value as the min1 that is provided from the find min1, min2 module. If yes, then the output from the corresponding decision module provides a select signal to a flip-flop (FF), whose output is then provided to the corresponding MUX which selects min1 or min2 selects min2 to be provided to the corresponding 2's complement conversion module. If no, then the output from the corresponding decision module provides a select signal to a flip-flop (FF), whose output is then provided to the corresponding MUX which selects min1 to be provided to the corresponding 2's complement conversion module.

Each flip-flop (FF) of another plurality of flip-flops (FFs) also receives the corresponding new sign from the FIG. 22. The output of this flip-flop (FF) is the sign input to the flip-flop (FF) that also receives the appropriately selected magnitude “mag” (output from the corresponding MUX). This sign and magnitude “mag” are both provided to the corresponding 2's complement conversion module whose output is provided to the corresponding subtractor that also receives the incoming variable/bit sum [from the FIG. 21].

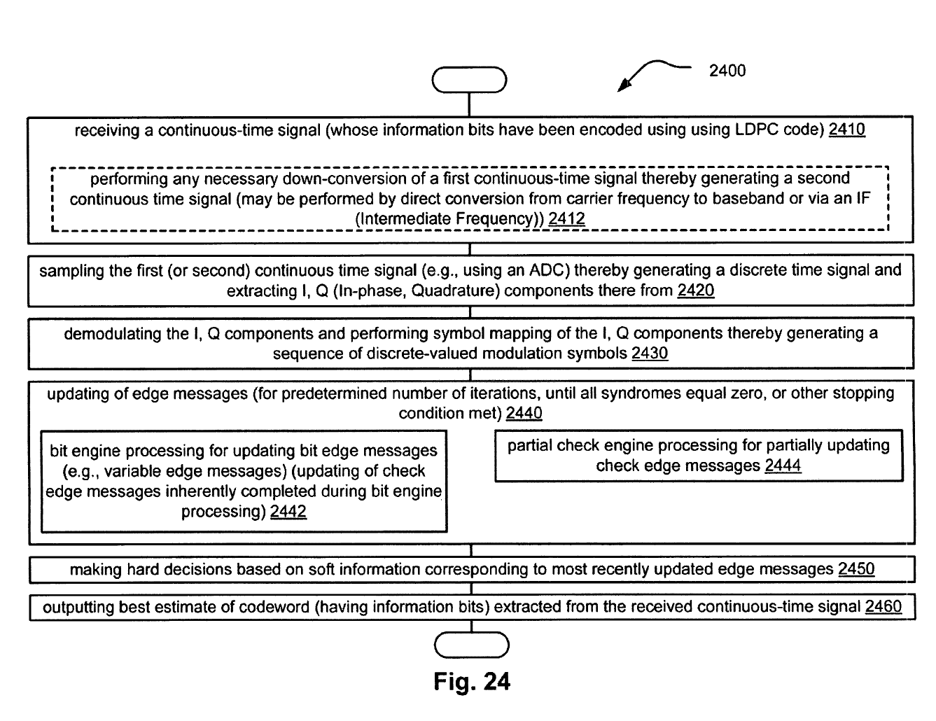

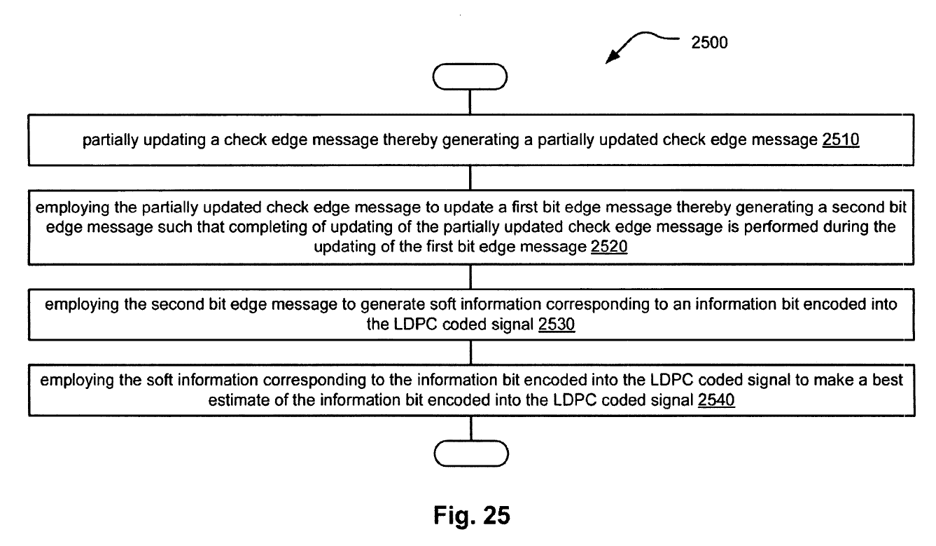

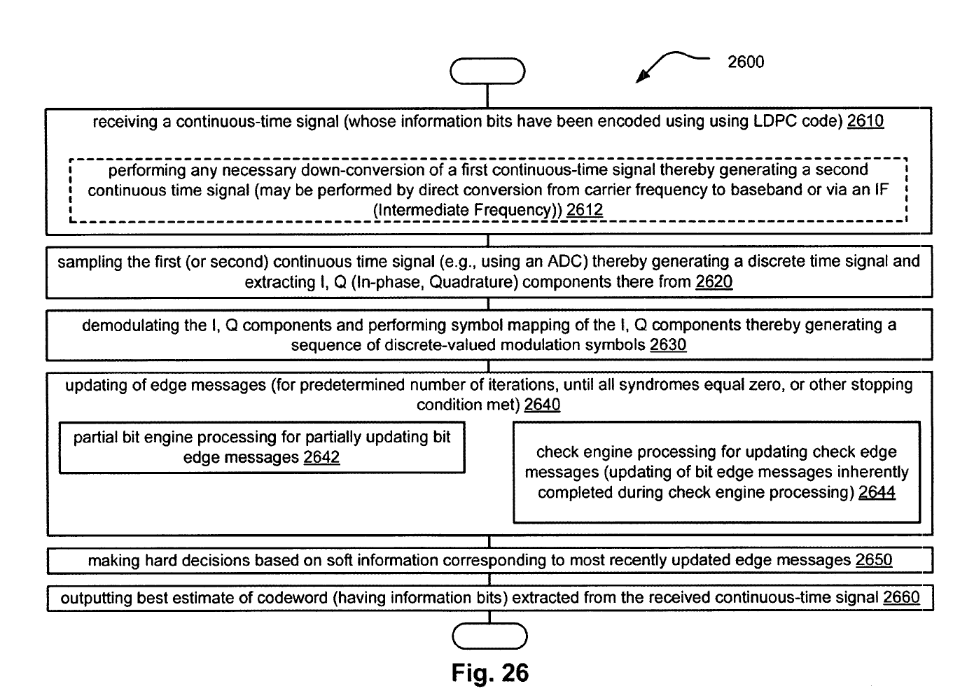

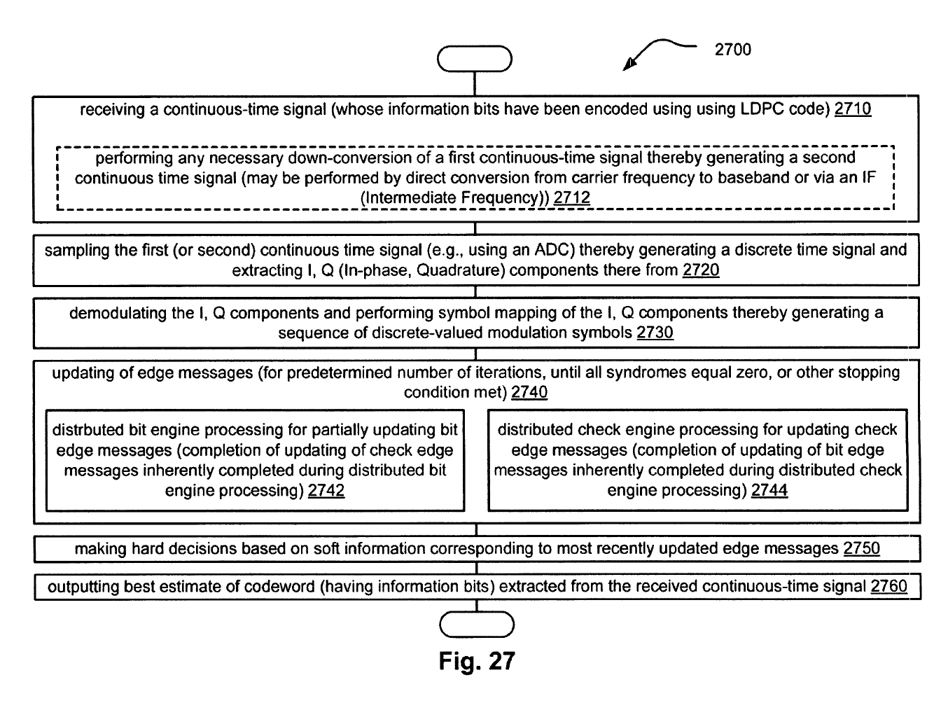

FIG. 24, FIG. 25, FIG. 26, and FIG. 27 illustrate alternative embodiments of a method for processing an LDPC coded signal.

Referring to the FIG. 24, the method 2400 initially involves receiving a continuous-time signal, as shown in a block 2410. This receiving and processing of the continuous-time signal may also involve performing any necessary down-conversion of a first continuous-time signal thereby generating a second continuous-time signal, as shown in a block 2412. Any frequency conversion that may need to be performed may possibly be performed by direct conversion from carrier frequency to a baseband frequency. This frequency conversion may alternatively be performed via an IF (Intermediate Frequency). In whichever embodiment, the received continuous-time signal is typically brought down in frequency to a baseband continuous-time signal when performing this method. Also, certain types of gain adjustment/gain control may be applied to the received continuous-time signal.

The method 2400 also involves sampling the first (or second) continuous-time signal thereby generating a discrete-time signal and extracting I, Q (In-phase, Quadrature) components there from, as shown in a block 2420. This sampling may be performed using an ADC (Analog to Digital Converter) or equivalent means to generate the discrete-time signal from the appropriately down-converted (and potentially also filtered, gain adjusted, etc.) received continuous-time signal. The I, Q components of the individual samples of the discrete time signal are also extracted within this step. The method 2400 then involves demodulating the I, Q components and can involve performing symbol mapping of the I, Q components (e.g., to a constellation shape having a mapping of the constellation points therein) thereby generating a sequence of discrete-valued modulation symbols, as shown in a block 2430.

The next step of the method 2400 involves performing updating of edge messages until a stopping condition is met (e.g., for a predetermined number of iterations, until all syndromes are equal to zero, or until some other stopping criterion is met), as shown in a block 2440. This step may be viewed as performing the LDPC decoding in accordance with any of the various embodiments described above. This LDPC decoding generally involves bit engine processing for updating bit edge messages (e.g., variable edge messages) (as shown in a block 2442) as well as check engine processing for partially updating check edge messages (as shown in a block 2444). It is noted that the updating of the check edge messages is inherently performed during the bit engine processing, as shown in the block 2442.

After the stopping condition has been met, the method 2400 involves making hard decisions based on soft information corresponding to most recently updated bit edge messages, as shown in a block 2450. The method 2400 ultimately involves outputting a best estimate of the LDPC coded bits (LDPC codeword, or LDPC code block) (that includes the information bits) that has been extracted from the received continuous-time signal, as shown in a block 2460.

Referring to the FIG. 25, the method 2500 initially involves partially updating a check edge message thereby generating a partially updated check edge message, as shown in a block 2510. The method 2500 then continues by employing the partially updated check edge message to update a first bit edge message thereby generating a second bit edge message such that completing of updating of the partially updated check edge message is performed during the updating of the first bit edge message, as shown in a block 2520.

The method 2500 then continues by employing the second bit edge message to generate soft information corresponding to an information bit encoded into the LDPC coded signal, as shown in a block 2530. The method 2500 then continues by employing the soft information corresponding to the information bit encoded into the LDPC coded signal to make a best estimate of the information bit encoded into the LDPC coded signal, as shown in a block 2540.

Referring to the FIG. 26, the method 2600 initially involves receiving a continuous-time signal, as shown in a block 2610. This receiving and processing of the continuous-time signal may also involve performing any necessary down-conversion of a first continuous-time signal thereby generating a second continuous-time signal, as shown in a block 2612. Any frequency conversion that may need to be performed may possibly be performed by direct conversion from carrier frequency to a baseband frequency. This frequency conversion may alternatively be performed via an IF (Intermediate Frequency). In whichever embodiment, the received continuous-time signal is typically brought down in frequency to a baseband continuous-time signal when performing this method. Also, certain types of gain adjustment/gain control may be applied to the received continuous-time signal.

The method 2600 also involves sampling the first (or second) continuous-time signal thereby generating a discrete-time signal and extracting I, Q (In-phase, Quadrature) components there from, as shown in a block 2620. This sampling may be performed using an ADC (Analog to Digital Converter) or equivalent means to generate the discrete-time signal from the appropriately down-converted (and potentially also filtered, gain adjusted, etc.) received continuous-time signal. The I, Q components of the individual samples of the discrete time signal are also extracted within this step. The method 2600 then involves demodulating the I, Q components and can involve performing symbol mapping of the I, Q components (e.g., to a constellation shape having a mapping of the constellation points therein) thereby generating a sequence of discrete-valued modulation symbols, as shown in a block 2630.

The next step of the method 2600 involves performing updating of edge messages until a stopping condition is met (e.g., for a predetermined number of iterations, until all syndromes are equal to zero, or until some other stopping criterion is met), as shown in a block 2640. This step may be viewed as performing the LDPC decoding in accordance with any of the various embodiments described above. This LDPC decoding generally involves partial bit engine processing for partially updating bit edge messages (e.g., variable edge messages) (as shown in a block 2642) as well as check engine processing for updating check edge messages (as shown in a block 2644). It is noted that the updating of the bit edge messages is inherently performed during the check engine processing, as shown in the block 2644.

After the stopping condition has been met, the method 2600 involves making hard decisions based on soft information corresponding to most recently updated bit edge messages, as shown in a block 2650. The method 2600 ultimately involves outputting a best estimate of the LDPC coded bits (LDPC codeword, or LDPC code block) (that includes the information bits) that has been extracted from the received continuous-time signal, as shown in a block 2660.

Referring to the FIG. 27, the method 2700 initially involves receiving a continuous-time signal, as shown in a block 2710. This receiving and processing of the continuous-time signal may also involve performing any necessary down-conversion of a first continuous-time signal thereby generating a second continuous-time signal, as shown in a block 2712. Any frequency conversion that may need to be performed may possibly be performed by direct conversion from carrier frequency to a baseband frequency. This frequency conversion may alternatively be performed via an IF (Intermediate Frequency). In whichever embodiment, the received continuous-time signal is typically brought down in frequency to a baseband continuous-time signal when performing this method. Also, certain types of gain adjustment/gain control may be applied to the received continuous-time signal.

The method 2700 also involves sampling the first (or second) continuous-time signal thereby generating a discrete-time signal and extracting I, Q (In-phase, Quadrature) components there from, as shown in a block 2720. This sampling may be performed using an ADC (Analog to Digital Converter) or equivalent means to generate the discrete-time signal from the appropriately down-converted (and potentially also filtered, gain adjusted, etc.) received continuous-time signal. The I, Q components of the individual samples of the discrete time signal are also extracted within this step. The method 2700 then involves demodulating the I, Q components and can involve performing symbol mapping of the I, Q components (e.g., to a constellation shape having a mapping of the constellation points therein) thereby generating a sequence of discrete-valued modulation symbols, as shown in a block 2730.

The next step of the method 2700 involves performing updating of edge messages until a stopping condition is met (e.g., for a predetermined number of iterations, until all syndromes are equal to zero, or until some other stopping criterion is met), as shown in a block 2740. This step may be viewed as performing the LDPC decoding in accordance with any of the various embodiments described above. This LDPC decoding generally involves distributed bit engine processing for partially updating bit edge messages (e.g., variable edge messages) (as shown in a block 2742) as well as distributed check engine processing for updating check edge messages (as shown in a block 2744).

It is noted that the updating of the bit edge messages is inherently performed during the distributed check engine processing, as shown in the block 2744, and the updating of the check edge messages is inherently performed during the distributed bit engine processing, as shown in the block 2742.

After the stopping condition has been met, the method 2700 involves making hard decisions based on soft information corresponding to most recently updated bit edge messages, as shown in a block 2750. The method 2700 ultimately involves outputting a best estimate of the LDPC coded bits (LDPC codeword, or LDPC code block) (that includes the information bits) that has been extracted from the received continuous-time signal, as shown in a block 2760.

In this disclosure, it is noted that once a low density parity check matrix, H, is available for use in decoding processing at a receiving end of a communication channel, the corresponding generator matrix, G, of the LDPC code may be generated straightforwardly from the low density parity check matrix, H. Having this information allows a designer to implement the encoding processing (using the generator matrix, G, of the LDPC code) at the transmitter end of the communication channel and also for decoding processing (using the low density parity check matrix, H, of the LDPC code) at the receiver end of the communication channel. In fact, it is common in the art that an LDPC code is defined directly from the low density parity check matrix, H. Stated another way, the low density parity check matrix, H, includes all of the necessary information to define the LDPC code.

It is noted that the various modules (e.g., encoding modules, decoding modules, bit engines, check engines, etc.) described herein may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The operational instructions may be stored in a memory. The memory may be a single memory device or a plurality of memory devices. Such a memory device may be a read-only memory, random access memory, volatile memory, non-volatile memory, static memory, dynamic memory, flash memory, and/or any device that stores digital information. It is also noted that when the processing module implements one or more of its functions via a state machine, analog circuitry, digital circuitry, and/or logic circuitry, the memory storing the corresponding operational instructions is embedded with the circuitry comprising the state machine, analog circuitry, digital circuitry, and/or logic circuitry. In such an embodiment, a memory stores, and a processing module coupled thereto executes, operational instructions corresponding to at least some of the steps and/or functions illustrated and/or described herein.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention.

One of average skill in the art will also recognize that the functional building blocks, and other illustrative blocks, modules and components herein, can be implemented as illustrated or by discrete components, application specific integrated circuits, processors executing appropriate software and the like or any combination thereof.

Moreover, although described in detail for purposes of clarity and understanding by way of the aforementioned embodiments, the present invention is not limited to such embodiments. It will be obvious to one of average skill in the art that various changes and modifications may be practiced within the spirit and scope of the invention, as limited only by the scope of the appended claims.

What is claimed is:

1. A decoder that is operable to decode an LDPC (Low Density Parity Check) coded signal, the decoder comprising:
a first processing module that is operable to employ a first check parity value and a first check sum value to generate a first bit edge message;
a second processing module that is operable to employ the first bit edge message to generate a second check parity value and a second check sum value, respectively; and wherein:
the first processing module is operable to employ the second check parity value and a second check sum value to update the first bit edge message thereby generating a second bit edge message; and
the first processing module is operable to employ the second bit edge message to generate soft information corresponding to an information bit encoded into the LDPC coded signal.

2. The decoder of claim 1, wherein:
the first processing module includes a plurality of XOR modules such that each XOR module is operable to receive the first check parity value and the first check sum value;
the second processing module includes a single XOR module that is operable to process a plurality of sign inputs received from the first processing module and to generate the first check parity value or the second check parity value.

3. The decoder of claim 1, wherein:
the first processing module includes a portion of check node processing circuitry and bit node processing circuitry.

4. The decoder of claim 1, wherein:
the first processing module includes a portion of check node processing circuitry and bit node processing circuitry; and
inclusion of the portion of check node processing circuitry within the first processing module is performed for optimizing electrical connection routing complexity between the first processing module and the second processing.

5. The decoder of claim 1, wherein:
the first processing module includes circuitry that enables the first processing module to complete updating of a check edge message using the first check parity value and the first check sum value.

6. The decoder of claim 1, wherein:
the first processing module is operable to perform min-sum processing when employing the first check parity value and the first check sum value to generate the first bit edge message.

7. The decoder of claim 1, wherein:
the second processing module is operable to perform min-sum processing when employing the first bit edge message to generate the second check parity value and the second check sum value, respectively.

8. The decoder of claim 1, wherein:
the decoder is operable to perform belief propagation decoding processing or message passing decoding processing.

9. The decoder of claim 1, wherein:
the decoder is implemented within an integrated circuitry.

10. The decoder of claim 1, wherein:
the decoder is implemented within a communication device that is operable to receive the LDPC coded signal from a communication channel; and
the communication device is implemented within at least one of a satellite communication system, a wireless communication system, a wired communication system, and a fiber-optic communication system.

11. A decoder that is operable to decode an LDPC (Low Density Parity Check) coded signal, the decoder comprising:
a first processing module that is operable to employ a first check parity value and a first check sum value to generate a first bit edge message;
a second processing module that is operable to employ the first bit edge message to generate a second check parity value and a second check sum value, respectively; and wherein:
the first processing module is operable to employ the second check parity value and a second check sum value to update the first bit edge message thereby generating a second bit edge message;
the first processing module is operable to employ the second bit edge message to generate soft information corresponding to an information bit encoded into the LDPC coded signal;
the first processing module includes a portion of check node processing circuitry and bit node processing circuitry; and
inclusion of the portion of check node processing circuitry within the first processing module is performed for optimizing electrical connection routing complexity between the first processing module and the second processing.

12. The decoder of claim 11, wherein:
the first processing module includes a plurality of XOR modules such that each XOR module is operable to receive the first check parity value and the first check sum value;
the second processing module includes a single XOR module that is operable to process a plurality of sign inputs received from the first processing module and to generate the first check parity value or the second check parity value.

13. The decoder of claim 11, wherein:
the first processing module is operable to perform min-sum processing when employing the first check parity value and the first check sum value to generate the first bit edge message; and
the second processing module is operable to perform min-sum processing when employing the first bit edge message to generate the second check parity value and the second check sum value, respectively.

14. The decoder of claim 11, wherein:
the decoder is operable to perform belief propagation decoding processing or message passing decoding processing.

15. The decoder of claim 11, wherein:
the decoder is implemented within an integrated circuitry.

16. The decoder of claim 11, wherein:
the decoder is implemented within a communication device that is operable to receive the LDPC coded signal from a communication channel; and
the communication device is implemented within at least one of a satellite communication system, a wireless communication system, a wired communication system, and a fiber-optic communication system.

17. A method for decoding an LDPC (Low Density Parity Check) coded signal, the method comprising:
employing a first check parity value and a first check sum value to generate a first bit edge message;
employing the first bit edge message to generate a second check parity value and a second check sum value, respectively;
employing the second check parity value and a second check sum value to update the first bit edge message thereby generating a second bit edge message; and
employing the second bit edge message to generate soft information corresponding to an information bit encoded into the LDPC coded signal.

18. The method of claim 17, further comprising:
performing min-sum processing when employing the first check parity value and the first check sum value to generate the first bit edge message; and
performing min-sum processing when employing the first bit edge message to update the first check parity value and the first check sum value, respectively, thereby generating the second check parity value and the second check sum value, respectively.

19. The method of claim 17, wherein:
the method is operable to perform belief propagation decoding processing or message passing decoding processing.

20. The method of claim 17, wherein:
the method is performed in a decoder;
the decoder is implemented within a communication device that is operable to receive the LDPC coded signal from a communication channel; and
the communication device is implemented within at least one of a satellite communication system, a wireless communication system, a wired communication system, and a fiber-optic communication system.
